(19) United States
(12) Patent Application Publication
(10) Pub. No.: US 2019/0287336 A1
(43) Pub. Date: Sep. 19, 2019

(54) Gaming Machine and Method with Bonus Symbol Position

(71) Applicant: Ainsworth Game Technology Limited, Newington (AU)

(72) Inventor: Sujay Prabhu, Newington (AU)

(21) Appl. No.: 15/923,448

(22) Filed: Mar. 16, 2018

(51) Int. Cl. G07F 17/32

(52) U.S. Cl. CPC G07F 17/3213; G07F 17/3262; G07F 17/3255; G07F 17/3227; G07F 17/3288; G07F 17/3206; G07F 17/3246; G07F 17/3248; G07F 17/3234; G07F 17/3239; G07F 17/3258

(57) ABSTRACT

A gaming machine comprises a display and an electronic controller for playing a game including game symbols displayed in symbol positions. The symbol positions may be arranged in two or more predefined groups or as reels. One or more symbol positions are designated as bonus symbol positions. A bonus value award associated with the bonus symbol is awarded when the bonus symbol appears in a bonus symbol position. In one embodiment, the number of designated bonus symbol positions is dependent on the player bet. In other embodiments, each predefined group or reel has a probability of displaying the bonus symbol and the probability of designating a symbol position as a bonus symbol position in the predefined group or on the reel depends on the probability of displaying the bonus symbol in the predefined group or on the reel.

### BACKGROUND

The present disclosure relates to a gaming machine and method. The present disclosure has been developed primarily for use as an electronic gaming machine and will be described hereinafter by reference to this application. However, it will be appreciated that the present disclosure may also be implemented for any type of gaming machine, including a mechanical or electro-mechanical gaming machine.

The following discussion of the prior art is intended to present the present disclosure in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Conventional gaming machines typically involve awarding prizes to a player according to predetermined combinations of game symbols that appear on an array of game squares displayed on a screen, typically organised into three rows and five columns (a 5×3 array). Other arrays, such as a 3×3 or 4×3, may be used. Each gaming machine randomly selects the game symbols that appear on the array, each column of the array being a “reel”.

One type of gaming machine comprises a mechanical or electro-mechanical device, where a motor rotates a plurality of annular rings or drums that form reels. Each reel has a reel strip that displays game symbols in preset game symbol positions. A frame covers the rings to provide a window through which only a subset of game symbol positions (and hence game symbols) were visible to the player. Thus, for a game using a 5×3 array, the window would only permit three rows of five rings to be visible to create the game array. An internal electronic controller within the gaming machine controls operation of the motor and hence rotation of the reels. Thus, by controlling when each reel starts and stops in its respective rotation, the electronic controller controls the display of the game symbols in the window. Sensors linked to the reels indicate which game symbols are displayed in the window and communicate with the electronic controller so that the electronic controller is able to award prizes based on winning combinations of game symbols displayed on the reels in the window. The electronic controller typically comprises one or more electric circuits for controlling various functions of the gaming machine, such as the above mentioned control of the motor, communicating with the sensors, verifying that the correct amount of a bet has been made via one or more value receiving mechanisms to enable operation of the motors, controlling any visual and/or audio effects associated with operation of the gaming machine and controlling operation of various alarms to alert any tampering with the gaming machine.

Another type of gaming machine, known as an electronic gaming machine or EGM, replaces the mechanical reels and motor with a video display screen on which video images of the reels are displayed. The EGM has an internal electronic game controller, typically a computer, that controls the display of images on the video display screen so that the reels are visibly spun on the screen to simulate a physical reel of a traditional gaming machine. EGMs tend to be more versatile in providing game information, varying the probabilities for a player to win a prize and varying the type of game that is played.

Bonus or “feature” games may also be provided by a gaming machine in addition to a base or main game. Typically feature games use the same set of reels as the main game and are limited to a set of free games operated under a single set of rules. This means that the feature game is restricted by the same set of rules, and so there is no variation in the play of the feature game. Also, gaming machines can offer one or more bonus prizes to the player during play of the game. The most common type of bonus prize that is awarded by the gaming machine is a jackpot prize, the main example of which is a progressive jackpot prize.

This standard structure to game play and bonus prizes limits the operation of the gaming machine, irrespective of whether it is a mechanical, electro-mechanical or electronic gaming machine. Consequently, it is difficult to retain player interest because there is no apparent incentive for the player to continue playing the gaming machine once the player becomes familiar with the feature game, the main game and any bonus prizes.

In addition, it is often difficult for a player to determine the likelihood of winning a bonus or jackpot prize because typically the jackpot prizes only indicated on the gaming machine by reference to the type of jackpot and an associated meter indicating the monetary amount of the jackpot. However, no other information regarding the jackpot is provided, such as the likelihood of winning the jackpot during a play or spin of a game on the gaming machine. Consequently, the player needs to infer that information or make a guess that a jackpot is “due” to be awarded. This often leads players to discontinue playing the game on the gaming machine as there is no incentive to win the jackpot.

It is an object of the present disclosure to overcome or substantially ameliorate one or more of the disadvantages of prior art, or at least to provide a useful alternative.

### SUMMARY

The present disclosure provides a gaming machine that has improved operation and performance relative to existing prior art gaming machines by providing a more efficient way of awarding prizes to a player of the gaming machine and/or optimising the use of screen space for the gaming machine compared to presently existing gaming machines. The present disclosure also improves the application of an electronic controller in playing the game on the gaming machine.

One embodiment of the present disclosure provides a gaming machine comprising:
a display; and
an electronic controller coupled to a display, the electronic controller being configured to:
   display a game on the display including one or more configurations of game symbols displayed in symbol positions arranged in two or more predefined groups of one or more symbol positions, one or more of the configurations of game symbols being associated with a winning game outcome, the winning game outcome being associated with a value award payable to a player;
   randomly designate one or more symbol positions as a bonus symbol position;
   randomly determine, for each bonus symbol position, whether to display a bonus symbol in the bonus symbol position, each predefined group having a probability of displaying the bonus symbol in one of the symbol positions of the predefined group; and
   award a bonus value award in response to one or more bonus symbols appearing in the bonus symbol positions, the bonus value award being associated with the bonus symbol;
   wherein the probability of a symbol position being designated as a bonus symbol position depends on probability of displaying the bonus symbol in one of the symbol positions of the predefined group.

A further embodiment of the present disclosure provides a gaming machine comprising:
a display;
an electronic controller coupled to a display, the electronic controller being configured to display a game on the display including one or more configurations of game symbols displayed in symbol positions arranged in two or more predefined groups of one of more symbol positions, one or more of the configurations of game symbols being associated with a winning game outcome, the winning game outcome being associated with a value award payable to a player; and
a value transfer mechanism for receiving value from the player, wherein the electronic controller communicates with the value transfer mechanism such that when a threshold amount of value has been received from the value transfer mechanism, the electronic controller initiates a play of the game;
the electronic controller being further configured to:
   randomly designate one or more symbol positions as a bonus symbol position;
   randomly determine, for each predefined group, whether to display a bonus symbol in one or more of the symbol positions of the predefined group, each predefined group having a probability of displaying the bonus symbol in the predefined group; and
   award a bonus value award in response to one or more bonus symbols appearing in the bonus symbol positions, the bonus value award being associated with the bonus symbol;
   wherein the probability of a symbol position being designated as a bonus symbol position depends on the probability of displaying the bonus symbol in the predefined group.

Yet another embodiment of the present disclosure provides a gaming machine comprising:
at least one display;
a value input comprising at least one of a coin acceptor, a bill acceptor and a ticket reader; and
at least one electronic controller coupled to the at least one display and the value input, the at least one controller configured:
   to determine if a wager has been received via the value input;
   to display a game on the at least one display including one or more configurations of game symbols displayed in symbol positions arranged in two or more predefined groups of one of more symbol positions if a wager has been received, one or more of the configurations of game symbols being associated with a winning game outcome, the winning game outcome being associated with a value award payable to a player;
   to randomly designate one or more symbol positions as a bonus symbol position;
   to randomly determine, for each predefined group, whether to display a bonus symbol in one or more of the symbol positions of the predefined group, each predefined group having a probability of displaying the bonus symbol in the predefined group; and
   to award a bonus value award in response to one or more bonus symbols appearing in the bonus symbol positions, the bonus value award being associated with the bonus symbol;
   wherein the probability of a symbol position being designated as a bonus symbol position depends on the probability of displaying the bonus symbol in the predefined group.

An additional embodiment of the present disclosure provides a gaming machine comprising:
a display; and
an electronic controller coupled to a display, the electronic controller being configured to:
   display a game on the display including a plurality of randomly selected game symbols arranged in a plurality of reels, one or more of the configurations of the randomly selected game symbols arranged along a pay line being associated with a winning game outcome, the winning game outcome being associated with a value award payable to a player;
   randomly designate one or more symbol positions on the reels as a bonus symbol position;
   randomly determine, for each reel, whether to display a bonus symbol in one or more bonus symbol positions of the reel based on a probability of displaying the bonus symbol on the reel; and
   award a bonus value award in response to one or more bonus symbols appearing in the bonus symbol positions, the bonus value award being associated with the bonus symbol;
   wherein the probability of a symbol position being designated as a bonus symbol position depends on the probability of displaying the bonus symbol on the reel.

A further embodiment of the present disclosure provides a gaming machine comprising:
a display;
an electronic controller coupled to a display, the electronic controller being configured to display a game on the display including a plurality of randomly selected game symbols arranged in a plurality of reels, one or more of the configurations of the randomly selected game symbols arranged along a pay line being associated with a winning game outcome, the winning game outcome being associated with a value award payable to a player; and
a value transfer mechanism for receiving value from the player, wherein the electronic controller communicates with the value transfer mechanism such that when a threshold amount of value has been received from the value transfer mechanism, the electronic controller initiates a play of the game;
the electronic controller being further configured to:
   randomly designate one or more symbol positions on the reels as a bonus symbol position;
   randomly determine, for each reel, whether to display a bonus symbol in one or more bonus symbol positions of the reel based on a probability of displaying the bonus symbol on the reel; and
   award a bonus value award in response to one or more bonus symbols appearing in the bonus symbol positions, the bonus value award being associated with the bonus symbol;
   wherein the probability of a symbol position being designated as a bonus symbol position depends on the probability of displaying the bonus symbol on the reel.

Yet another embodiment of the present disclosure provides a gaming machine comprising:
at least one display;
a value input comprising at least one of a coin acceptor, a bill acceptor and a ticket reader; and
at least one electronic controller coupled to the at least one display and the value input, the at least one controller configured:
   to determine if a wager has been received via the value input;
   to display a game on the at least one display including one or more configurations of game symbols displayed in symbol positions arranged in two or more predefined groups of one of more symbol positions if a wager has been received, one or more of the configurations of game symbols being associated with a winning game outcome, the winning game outcome being associated with a value award payable to a player;
   to randomly designate one or more symbol positions on the reels as a bonus symbol position;
   to randomly determine, for each reel, whether to display a bonus symbol in one or more bonus symbol positions of the reel based on a probability of displaying the bonus symbol on the reel; and
   to award a bonus value award in response to one or more bonus symbols appearing in the bonus symbol positions, the bonus value award being associated with the bonus symbol;
   wherein the probability of a symbol position being designated as a bonus symbol position depends on the probability of displaying the bonus symbol on the reel.

An additional embodiment of the present disclosure provides a gaming machine comprising:
a display; and
an electronic controller coupled to a display, the electronic controller being configured to:
   display a game on the display including one or more configurations of game symbols displayed in symbol positions, one or more of the configurations of game symbols being associated with a winning game outcome, the winning game outcome being associated with a value award payable to a player;
   designate one or more symbol positions as a bonus symbol position;
   randomly determine, for each bonus symbol position, whether to display a bonus symbol in the bonus symbol position; and
   award a bonus value award in response to one or more bonus symbols appearing in the bonus symbol positions, the bonus value award being associated with the bonus symbol;
   wherein the number of bonus symbol positions that are designated is dependent on the bet made by the player to play the game.

A further embodiment of the present disclosure provides a gaming machine comprising:
a display;
an electronic controller coupled to a display, the electronic controller being configured to display a game on the display including one or more configurations of game symbols displayed in symbol positions, one or more of the configurations of game symbols being associated with a winning game outcome, the winning game outcome being associated with a value award payable to a player; and
a value transfer mechanism for receiving value from the player, wherein the electronic controller communicates with the value transfer mechanism such that when a threshold amount of value has been received from the value transfer mechanism, the electronic controller initiates a play of the game;
the electronic controller being further configured to:
   designate one or more symbol positions as a bonus symbol position;
   randomly determine, for each bonus symbol position, whether to display a bonus symbol in the bonus symbol position; and
   award a bonus value award in response to one or more bonus symbols appearing in the bonus symbol positions, the bonus value award being associated with the bonus symbol;
   wherein the number of bonus symbol positions that are designated is dependent on the bet made by the player to play the game.

Yet another embodiment of the present disclosure provides a gaming machine comprising:
at least one display;
a value input comprising at least one of a coin acceptor, a bill acceptor and a ticket reader; and
at least one electronic controller coupled to the at least one display and the value input, the at least one controller configured:
   to determine if a wager has been received via the value input;
   to display a game on the display including one or more configurations of game symbols displayed in symbol positions, one or more of the configurations of game symbols being associated with a winning game outcome, the winning game outcome being associated with a value award payable to a player;
   to designate one or more symbol positions as a bonus symbol position;
   to randomly determine, for each bonus symbol position, whether to display a bonus symbol in the bonus symbol position; and
   to award a bonus value award in response to one or more bonus symbols appearing in the bonus symbol positions, the bonus value award being associated with the bonus symbol;
   wherein the number of bonus symbol positions that are designated is dependent on the bet made by the player to play the game.

An additional embodiment of the disclosure provides a method comprising:
displaying a game on the display including one or more configurations of game symbols displayed in symbol positions arranged in two or more predefined groups of one or more symbol positions, one or more of the configurations of game symbols being associated with a winning game outcome, the winning game outcome being associated with a value award payable to a player;
randomly designating one or more symbol positions as a bonus symbol position;
randomly determining, for each bonus symbol position, whether to display a bonus symbol in the bonus symbol position, each predefined group having a probability of displaying the bonus symbol in one of the symbol positions of the predefined group; and
awarding a bonus value award in response to one or more bonus symbols appearing in the bonus symbol positions, the bonus value award being associated with the bonus symbol;
wherein the probability of a symbol position being designated as a bonus symbol position depends on probability of displaying the bonus symbol in one of the symbol positions of the predefined group.

A yet further embodiment provides a method comprising:
receiving value via a value transfer mechanism;
determining whether the received value meets a threshold amount;
initiating a play of a game if the received value is equal to or greater than the threshold amount;
displaying a game on the display including one or more configurations of game symbols displayed in symbol positions arranged in two or more predefined groups of one or more symbol positions, one or more of the configurations of game symbols being associated with a winning game outcome, the winning game outcome being associated with a value award payable to a player
randomly designating one or more symbol positions as a bonus symbol position;
randomly determining, for each bonus symbol position, whether to display a bonus symbol in the bonus symbol position, each predefined group having a probability of displaying the bonus symbol in one of the symbol positions of the predefined group; and
awarding a bonus value award in response to one or more bonus symbols appearing in the bonus symbol positions, the bonus value award being associated with the bonus symbol;
wherein the probability of a symbol position being designated as a bonus symbol position depends on probability of displaying the bonus symbol in one of the symbol positions of the predefined group.

Yet another embodiment provides a method comprising:
determining if a wager has been received via a value input comprising at least one of a coin acceptor, a bill acceptor and a ticket reader;
displaying a game on the display including one or more configurations of game symbols displayed in symbol positions arranged in two or more predefined groups of one or more symbol positions, one or more of the configurations of game symbols being associated with a winning game outcome, the winning game outcome being associated with a value award payable to a player
randomly designating one or more symbol positions as a bonus symbol position;
randomly determining, for each bonus symbol position, whether to display a bonus symbol in the bonus symbol position, each predefined group having a probability of displaying the bonus symbol in one of the symbol positions of the predefined group; and
awarding a bonus value award in response to one or more bonus symbols appearing in the bonus symbol positions, the bonus value award being associated with the bonus symbol;
wherein the probability of a symbol position being designated as a bonus symbol position depends on probability of displaying the bonus symbol in one of the symbol positions of the predefined group.

An additional embodiment of the disclosure provides a method comprising:
displaying a game on the display including a plurality of randomly selected game symbols arranged in a plurality of reels, one or more of the configurations of the randomly selected game symbols arranged along a pay line being associated with a winning game outcome, the winning game outcome being associated with a value award payable to a player;
randomly designating one or more symbol positions on the reels as a bonus symbol position;
randomly determining, for each reel, whether to display a bonus symbol in one or more bonus symbol positions of the reel based on a probability of displaying the bonus symbol on the reel; and
awarding a bonus value award in response to one or more bonus symbols appearing in the bonus symbol positions, the bonus value award being associated with the bonus symbol;
wherein the probability of a symbol position being designated as a bonus symbol position depends on the probability of displaying the bonus symbol on the reel.

A yet further embodiment provides a method comprising:
receiving value via a value transfer mechanism;
determining whether the received value meets a threshold amount;
initiating a play of a game if the received value is equal to or greater than the threshold amount;
displaying a game on the display including a plurality of randomly selected game symbols arranged in a plurality of reels, one or more of the configurations of the randomly selected game symbols arranged along a pay line being associated with a winning game outcome, the winning game outcome being associated with a value award payable to a player;
randomly designating one or more symbol positions on the reels as a bonus symbol position;
randomly determining, for each reel, whether to display a bonus symbol in one or more bonus symbol positions of the reel based on a probability of displaying the bonus symbol on the reel; and
awarding a bonus value award in response to one or more bonus symbols appearing in the bonus symbol positions, the bonus value award being associated with the bonus symbol;
wherein the probability of a symbol position being designated as a bonus symbol position depends on the probability of displaying the bonus symbol on the reel.

Yet another embodiment provides a method comprising:
determining if a wager has been received via a value input comprising at least one of a coin acceptor, a bill acceptor and a ticket reader;
displaying a game on the display including a plurality of randomly selected game symbols arranged in a plurality of reels, one or more of the configurations of the randomly selected game symbols arranged along a pay line being associated with a winning game outcome, the winning game outcome being associated with a value award payable to a player;
randomly designating one or more symbol positions on the reels as a bonus symbol position;
randomly determining, for each reel, whether to display a bonus symbol in one or more bonus symbol positions of the reel based on a probability of displaying the bonus symbol on the reel; and
awarding a bonus value award in response to one or more bonus symbols appearing in the bonus symbol positions, the bonus value award being associated with the bonus symbol;
wherein the probability of a symbol position being designated as a bonus symbol position depends on the probability of displaying the bonus symbol on the reel.

An additional embodiment of the disclosure provides a method comprising:
displaying a game on the display including one or more configurations of game symbols displayed in symbol positions, one or more of the configurations of game symbols being associated with a winning game outcome, the winning game outcome being associated with a value award payable to a player;
designating one or more symbol positions as a bonus symbol position;
randomly determining, for each bonus symbol position, whether to display a bonus symbol in the bonus symbol position; and
awarding a bonus value award in response to one or more bonus symbols appearing in the bonus symbol positions, the bonus value award being associated with the bonus symbol;
wherein the number of bonus symbol positions that are designated is dependent on the bet made by the player to play the game.

A yet further embodiment provides a method comprising:
receiving value via a value transfer mechanism;
determining whether the received value meets a threshold amount;
initiating a play of a game if the received value is equal to or greater than the threshold amount;
displaying a game on the display including one or more configurations of game symbols displayed in symbol positions, one or more of the configurations of game symbols being associated with a winning game outcome, the winning game outcome being associated with a value award payable to a player;
designating one or more symbol positions as a bonus symbol position;
randomly determining, for each bonus symbol position, whether to display a bonus symbol in the bonus symbol position; and
awarding a bonus value award in response to one or more bonus symbols appearing in the bonus symbol positions, the bonus value award being associated with the bonus symbol;
wherein the number of bonus symbol positions that are designated is dependent on the bet made by the player to play the game.

Yet another embodiment provides a method comprising:
determining if a wager has been received via a value input comprising at least one of a coin acceptor, a bill acceptor and a ticket reader;
displaying a game on the display including one or more configurations of game symbols displayed in symbol positions, one or more of the configurations of game symbols being associated with a winning game outcome, the winning game outcome being associated with a value award payable to a player;
designating one or more symbol positions as a bonus symbol position;
randomly determining, for each bonus symbol position, whether to display a bonus symbol in the bonus symbol position; and
awarding a bonus value award in response to one or more bonus symbols appearing in the bonus symbol positions, the bonus value award being associated with the bonus symbol;
wherein the number of bonus symbol positions that are designated is dependent on the bet made by the player to play the game.

A further embodiment provides a computer system comprising a central processing unit configured for communication with a gaming machine, wherein the computer system is configured to perform the method of any one of the above described embodiments of the present disclosure.

A further embodiment provides a computer program configured to perform the method of any one of the above described embodiments of the present disclosure.

A further embodiment provides a non-transitory carrier medium carrying computer executable code that, when executed on a central processing unit configured for communication with a gaming machine, causes the central processing unit to perform the method of any one of the above described embodiments of the present disclosure.

Throughout the specification and unless explicitly stated otherwise, the term “value” means credits, gaming tokens, coins, paper, currency, tickets, vouchers, credit cards, debit cards, smart cards, memory devices capable of storing value and any other object representative of value.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### BRIEF DESCRIPTION OF THE DRAWINGS

The disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings is necessarily to scale.

FIG. 1 is a perspective view of a gaming machine according to a first embodiment of the present disclosure.

FIG. 2 is a schematic drawing of an electronic controller for the gaming machine of FIG. 1.

FIG. 3 is a simulated screen shot of a base game shown on the display of the gaming machine of FIG. 1.

FIGS. 4 to 6 are simulated screen shots of another base game shown on the display of the gaming machine of FIG. 1.

FIG. 7 is a schematic drawing of reel strips for use in the base games of FIGS. 3 to 6.

FIGS. 8 to 10F. are simulated screen shots of a further base game shown on the display of the gaming machine of FIG. 1.

FIGS. 11 and 12 are simulated screen shots of a feature game shown on the display of the gaming machine of FIG. 1.

FIGS. 13 to 15 are simulated screen shots of yet another base game shown on the display of the gaming machine of FIG. 1.

FIG. 16 illustrates in overview the method by which the electronic game controller operates according to embodiments of the disclosure.

FIG. 17 is a perspective view of an electronic gaming machine according to yet another embodiment of the present disclosure.

FIG. 18 is a schematic drawing of a control panel for the electronic gaming machine of FIG. 17.

FIG. 19 is a block diagram of the electronic components of the electronic gaming machine of FIG. 17.

### DETAILED DESCRIPTION OF VARIOUS EMBODIMENTS

The present disclosure will now be described with reference to the following examples which should be considered in all respects as illustrative and non-restrictive. In the Figures, corresponding features within the same embodiment or common to different embodiments have been given the same reference numerals.

In general terms, a gaming machine according to the embodiments described herein includes at least one display, and an electronic controller coupled to the at least one display. In some embodiments, the gaming machine comprises a value transfer mechanism or a value input that is coupled to the electronic controller. The value input may comprise at least one of a coin acceptor, a bill acceptor and a ticket reader.

The electronic controller, in one embodiment, is configured to display a game on the display including one or more configurations of game symbols displayed in symbol positions, one or more of the configurations of game symbols being associated with a winning game outcome, the winning game outcome being associated with a value award payable to a player. In another embodiment, the electronic controller is configured to display the symbol positions arranged in two or more predefined groups of one or more symbol positions. In a further embodiment, the electronic controller is configured to display the game as including a plurality of randomly selected game symbols arranged in a plurality of reels, one or more of the configurations of the randomly selected game symbols arranged along a pay line being associated with a winning game outcome.

Where the symbol positions are arranged in two or more predefined groups, the probability of a symbol position being designated as a bonus symbol position depends on the probability of displaying the bonus symbol in the predefined group. In some embodiments, the probability of displaying the bonus symbol in a predefined group comprises a probability of displaying the bonus symbol in one of the symbol positions of the predefined group. In other embodiments, the probability of displaying the bonus symbol in a predefined group comprises a probability of displaying two or more bonus symbols in two or more symbol positions of the predefined group. In a further embodiment, the probability of displaying the bonus symbol in a predefined group comprises a probability of displaying the bonus symbol in each symbol position of the predefined group. In one embodiment, probability of a symbol position being designated as a bonus symbol position depends on the number of bonus symbols that may appear in the predefined group.

In some embodiments, the electronic controller is configured to randomly determine, for each symbol position, whether to display a bonus symbol in the symbol position based on the probability of displaying the bonus symbol in the predefined group.

In some embodiments, the probability of displaying the bonus symbol in a predefined group is the same for each symbol position in the predefined group.

In some embodiments, the probability of a symbol position being designated as a bonus symbol position is less than the probability of displaying the bonus symbol in the predefined group. In a further embodiment, the probability of a symbol position being designated as a bonus symbol position is proportional to the probability of displaying the bonus symbol in the predefined group. In other embodiments, the probability of a symbol position being designated as a bonus symbol position is higher than the probability of displaying the bonus symbol in the predefined group.

In one embodiment, the predefined groups are associated with different sets of the game symbols and bonus symbols and a set is selected for at least one predefined group based on the bet made by the player to play the game. Preferably, each predefined group is associated with more than one set of game symbols and bonus symbols. In some embodiments, an increase in the amount of the bet made by the player results in selection of a set having a greater number of bonus symbols for the at least one predefined group. In other embodiments, there are different types of bonus symbols, each type of bonus symbol being associated with a different bonus value award and an increase in the amount of the bet made by the player results in selection of a set having a greater number of bonus symbols of one or more types of bonus symbol that are associated with higher bonus value awards.

In some embodiments, there are different types of bonus symbols, each type of bonus symbol being associated with a different bonus value award. In other embodiments, the type of bonus symbol that appears in the bonus symbol position or symbol position is dependent on the bet made by the player to play the game.

In some embodiments, there is a constant number of bonus symbol positions designated in each play of the game. In other embodiments, there is a constant number of designated bonus symbol positions for any two successive plays of the game. In further embodiments, the designated bonus symbol positions may move or stay in the same symbol position between plays of the game.

In a further embodiment, two or more of the bonus symbols in at least one set are displayed in adjacent symbol positions of the at least one predefined group.

In another embodiment, the predefined groups comprise reels, each reel being associated with one or more reel strips having a plurality of the game symbols and bonus symbols, wherein the reel strip selected for each reel depends on the amount of the bet made by the player to play the game. Preferably, an increase in the amount of the bet made by the player results in selection of a reel strip having a greater number of bonus symbols for the reel. It is also preferred that two or more bonus symbols in at least one reel strip are displayed as a stack of symbols on the reel.

Where the plurality of randomly selected game symbols arranged in a plurality of reels, the probability of a symbol position being designated as a bonus symbol position depends on the probability of displaying the bonus symbol on the reel. In some embodiments, the probability of displaying the bonus symbol on a reel comprises a probability of displaying the bonus symbol in one of the symbol positions of the reel. In further embodiments, the probability of displaying the bonus symbol on a reel comprises a probability of displaying two or more bonus symbols in two or more symbol positions of the reel. In other embodiments, the probability of displaying the bonus symbol on a reel comprises a probability of displaying the bonus symbol in each symbol position of the reel.

In some embodiments, the probability of a symbol position being designated as a bonus symbol position is less than the probability of displaying the bonus symbol in the reel. In other embodiments, the probability of a symbol position being designated as a bonus symbol position is proportional to the probability of displaying the bonus symbol in the reel. In further embodiments, the probability of a symbol position being designated as a bonus symbol position is higher than the probability of displaying the bonus symbol in the reel.

In some embodiments, the electronic controller is configured to randomly determine, for each symbol position of each reel, whether to display a bonus symbol in the symbol position based on the probability of displaying the bonus symbol on the reel.

In some embodiments, each reel is associated with one or more reel strips having a plurality of game symbols and bonus symbols and a reel strip is selected for at least one reel based on the bet made by the player to play the game. In other embodiments, the reel strips selected for each reel depend on the amount of the bet made by the player to play the game. Preferably, an increase in the amount of the bet made by the player results in selection of a reel strip having a greater number of bonus symbols. In some embodiments, the bonus symbols are displayed as stacks of symbols on the reel strips.

In some embodiments, there are different types of bonus symbols, each type of bonus symbol being associated with a different bonus value award and an increase in the amount of the bet made by the player results in selection of a reel strip having a greater number of bonus symbols of one or more types of bonus symbols that are associated with higher bonus value awards.

In the embodiment where one or more configurations of game symbols are simply displayed in symbol positions, the number of bonus symbol positions that are designated is dependent on the bet made by the player to play the game. In some embodiments, the number of bonus symbol positions that are designated increases as the amount of a bet increases. Preferably, there are different types of bonus symbols and the electronic controller is configured to randomly determine, for each bonus symbol position, whether to display one of the different types of bonus symbols in the bonus symbol position. It is also preferred that a bonus symbol position designated in a first play of the game is retained as a bonus symbol position for one or more successive plays of the game. More preferably, the bonus symbol position moves between successive plays of the game.

Where the number of bonus symbol positions that are designated is dependent on the bet made by the player to play the game, in some embodiments, the electronic controller randomly designates the bonus symbol positions. In other embodiments, the electronic controller designates the bonus symbol positions according to a set order or pattern. In further embodiments, the player designates the bonus symbol positions.

In some embodiments, a multiplier is associated with the bonus symbol positions and the multiplier, when activated, increases the amount of the bonus value award. Preferably, the multiplier is activated when a bonus symbol appears in one of the bonus symbol positions. It is also preferred that the multiplier is randomly selected from a range of multipliers. In other embodiments, the multiplier is selected from a multiplier reel. In a further embodiment, the multiplier is associated with the bonus symbol position upon payment of an ante bet.

In some embodiments, the number of bonus symbol positions increase for one or more successive plays of the game.

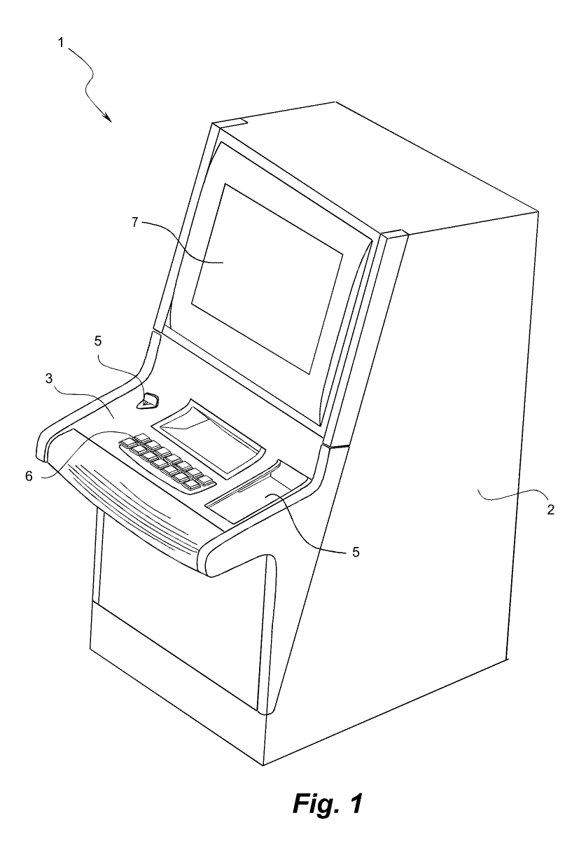

Referring to FIG. 1, a gaming machine 1 according to a first embodiment includes a cabinet 2, a console 3 and an internal electronic controller 4. The console 3 has various input devices including value inputs, such as vending slots 5 for receiving monetary bets, and a plurality of buttons 6 for actuation by a player. It will be appreciated that in other embodiments the vending slots 5 may be replaced with other types of value input/value output devices, such as a coin acceptor, a paper currency acceptor, a ticket reader and/or printer or a card reader and/or writer.

The vending slots 5 can be configured to receive value, such as cash in the form of banknotes and coins, or credits representing a monetary amount from a memory device, such as but not limited to a memory card, smart card, a radio frequency identification (RFID) device, USB key, magnetic card or other electronic storage device. Typically, the memory device is a credit card, debit card or other card that enables the transfer of monetary credit to the gaming machine 1. Other forms of value include gaming tokens, paper, tickets, vouchers, and any other object representative of value.

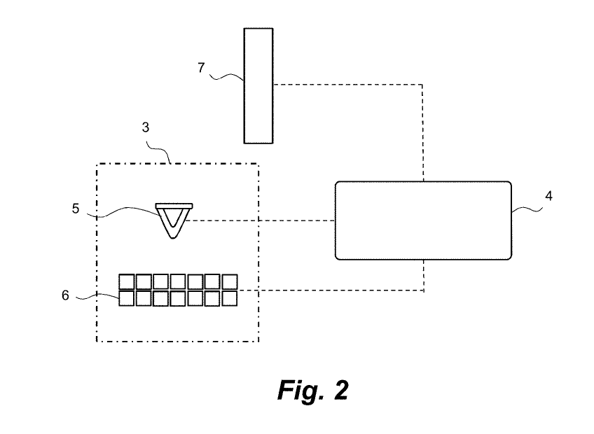

The electronic controller 4 is generally in the form of an electronic game controller comprising a central processing unit, such as a computer, and is in electronic communication with a display in the form of a video display screen 7, as well as various input devices on the console 3, as best shown in FIG. 2. Typically, the electronic game controller 4 also comprises a random access memory (RAM) associated with the central processing unit, the RAM being used to store programme instructions and transient data related to the operation of the electronic game controller and hence the gaming machine 1. The RAM contains a body of program instructions for implementing a game on the gaming machine 1, as discussed in more detail below. The central processing unit or processor may also be operatively associated with a further storage device, such as a hard disk drive, which is used for long-term storage of program components and data relating to the electronic game controller 4 and/or the gaming machine 1, including a database for game performance data, as well as information gathered from users. It is also appreciated that a person skilled in the art would readily understand the location and use of the electronic game controller 4 in the gaming machine 1.

The electronic game controller 4 will transmit and receive signals to and from each of the input devices and the display 7, usually via wired connections but can include wireless modes of electronic communication, such as WLAN. In the case of the vending slots 5 (or with any other type of value transfer mechanism), there may be an intermediate credit verification device that examines and verifies the cash or credits received by the vending slots. Once the value (such as cash or credits) have been verified by the credit verification device, a signal is sent to the electronic game controller 4, which then determines whether the minimum bet level has been reached. If so, the electronic game controller 4 will permits play of the game on the gaming machine 1. If not, the electronic game controller 4 will send a signal to the display 7 to show a message requesting further value to be added to the gaming machine 1.

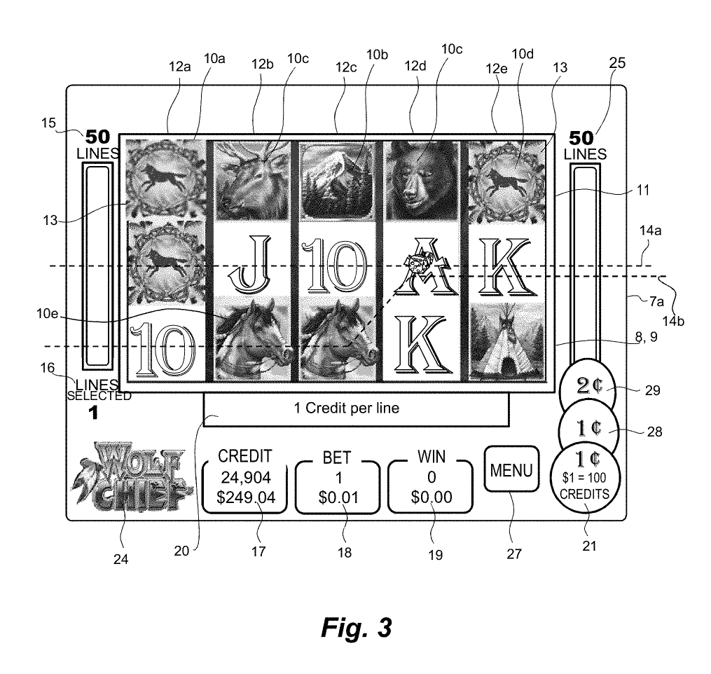

The electronic game controller 4 is programmed to provide a game in the form of a base game 8 and a feature game 9 (as best shown in FIG. 3) on a lower playing area 7a of the display 7 of the gaming machine 1 for play by a player. An upper display area is reserved for showing artwork associated with the game(s) that are available for play on the gaming machine and/or other game information. The base game 8 has game symbols 10 arranged into an array 11 in the form of five columns or “reels” 12. The reels 12 give the visual appearance of rotating, typically by having the game symbols 10 move in a downward linear path along the length of each reel 12. While the array 11 is arranged with five reels 12 and three rows as per the industry standard, it will be appreciated by one skilled in the art that other types of arrays could be used, such as 3×3, 4×3, 5×5, 4×4, etc, including arrays having an irregular number of rows and/or columns. For example, the array 11 can have an unequal number of rows and/or columns, where some columns have less or more rows than other columns or where some rows have less or more columns than other rows. A more specific example would be an array having three columns with only two rows and two columns with three rows. The electronic game controller 4 will transmit signals to the display screen 7 to cause the base game 8 and feature game 9 to be played on the lower playing area 7a, including showing the game symbols 10, array 11 and other visible elements of the games.

The array 11 of the base game 8 defines predetermined game or symbol positions 13, in which the game symbols 10 appear. The symbol positions 13 are not visually marked by boundary lines and simply provide an area for the game symbols 10 to appear. However, it will be appreciated that in other embodiments, the symbol positions 13 are defined by visible boundary lines (to define “squares” or game positions) or other markings to define each respective area of the symbol positions.

The array 11 is arranged so that a player can select one or more predetermined “pay lines” 14 defined around the array, which correspond to combinations of the symbol or game positions 13. The combinations of symbol positions 13 are predefined by the body of programme instructions relating to the base game 8, as stored in the RAM associated with the electronic controller 4. The pay lines 14a, 14b correspond to the lines selected by the player and generally comprise at least one game position or symbol position 13 from each reel 12. The number of pay lines 14 that can be selected by the player depends on the amount of the monetary bet for playing a game on the array 11. In the base game 8, predetermined winning combinations of randomly selected game symbols 10 result in the award of prizes to the player.

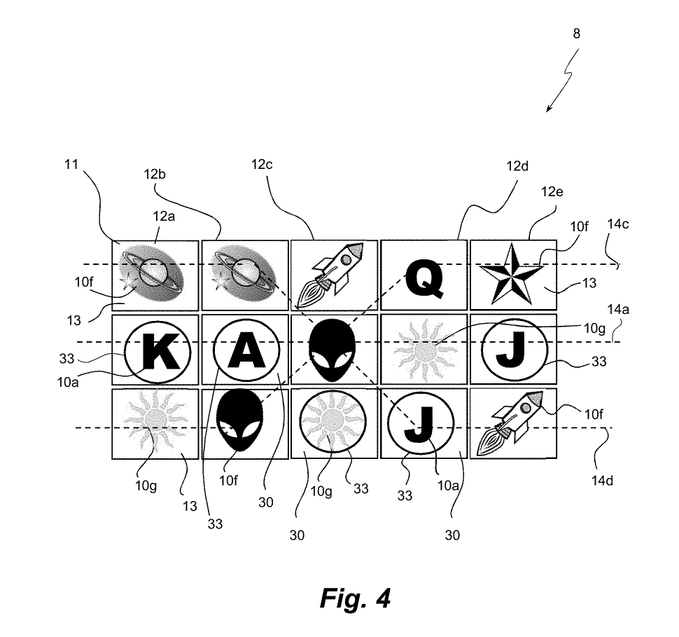

The game symbols 10 can include a mixture of picture symbols (such as animal symbols or playing card symbols), word symbols, scatter symbols, substitute or wild card symbols and trigger symbols to trigger the feature game 9. Those skilled in the art will readily understand that a substitute symbol is able to act as any other game symbol, and hence is also known as a “wild card” symbol. Likewise, those skilled in the art will readily understand that a scatter symbol is a symbol that triggers a game event or confers an award without having to appear on a player-selected pay line 14. Similarly, a trigger symbol is a symbol that triggers a game event or confers an award, where the trigger symbol may or may not have to appear in combination and may or may not have to appear on the same player-selected pay line 14. In a typical game shown in FIG. 3, the game symbols 10 include playing card symbols 10a, animal-themed symbols 10b, item-themed symbols 10c, scatter symbols in the form of “wolf banner” symbols 10d and a substitute or wild card symbol in the form of horse symbols 10e. In one embodiment shown in FIG. 4, the game symbols 10 generally involve a space theme so that the game symbols 10 include space-themed picture symbols 10f and wild card Sun symbol 10g. The electronic game controller 4 randomly determines the appearance of the game symbols 10 on the array 11.

The video screen 7 also displays other standard game information in the lower playing area 7a, including the number of pay lines available 15, the number of player-selected pay lines 16, the amount of player credits 17 (i.e. credit meter), the amount of the current bet wagered by the player 18, the amount of wins by the player 19 (i.e. win meter), a message area 20, a current denomination button 21 indicating the currently selected base bet denomination and the name 24 of the base game 8, Wolf Chief™, as best shown in FIG. 3. In other embodiments, the video screen 7 displays a menu button for bringing up a menu screen (typically explaining the game rules and showing the available pay lines 14) and/or jackpot information relating to the based game 8 and feature game 9 that are awarded by the electronic gaming machine 1. This jackpot information is typically displayed in the upper display area and can comprise, in descending order of monetary value, a grand jackpot, major jackpot, minor jackpot and midi jackpot.

In the base game 8, the player initially makes a bet using vending slots 5 to initiate play of the gaming machine 1 by building up credit to play the base game 8 on the gaming machine. For example, the player can bet or wager monetary amounts equivalent to a particular amount of credits, depending on the bet denomination selected for the base game. Also, the player can make any additional side bets or ante-bets during play of the base game 8 once the base game has commenced to access additional features in the base game, such as increasing the number of winning combinations in the base game.

Typically, gaming machines offer a number of preset bet options that the player can make, and these bet options can vary depending on the game or games offered on the gaming machine. For example, a game on a gaming machine may provide bet options of 1 credit, 2 credits, 5 credits and 10 credits per player-selected pay line 14. In another example, the player may bet 1 credit, 2 credits, 5 credits and 10 credits for a preset group or combination of pay lines 14, such as a group of 5 pay lines, 10 pay lines, 20 pay lines, etc.

The gaming machine 1 also has a default bet denomination, which is usually the bet denomination that was previously used in the preceding play of the base game 8. For example, if a person had played the base game 8 with a bet denomination of 50, then this would be the default bet denomination for the player when he or she commences play of the game. Where the gaming machine has not yet been played or has been started up, the default bet denomination is initially selected by the electronic game controller 4. The default bet denomination can be randomly selected or chosen according to a predetermined order. Usually, the electronic game controller 4 will select the bet denomination with the lowest value that is available for the base game 8, which would be the 1¢ bet denomination for this embodiment. The player may change the bet denomination at any time in the base game 8 by touching the denomination button 21 before or after the reels 12 have spun. In this embodiment, touching the denomination button will bring denomination images 28, 29 that the player may select to quickly change the bet denomination between plays of the game 8.

Once the player has commenced play of the game 8 by making an appropriate bet via the vending slots 5, the electronic game controller 4 then commences a play of the base game 8 by sending a signal to the display 7 to cause the reels 12 to appear to visibly rotate or “spin” in a linear path, typically in a downward vertical direction, and randomly display the game symbols 10 in each game position for each play of the array 11 for the base game 8. The electronic game controller 4 then randomly determines which symbols 10 are displayed in each symbol position 13 of the reels 12. There are various ways in which this random determination is made. For example, one way is to associate each reel 12a to 12e with a reel strip that contains a series of game symbols 10 in a predetermined order along its length. Some of the game symbols may repeat (such as five Ace symbols in the same strip) and even repeat successively (such as three Ace symbols adjacent each other to form a “stack” of symbols). The number of game symbols and types of game symbols may vary with each reel strip. Accordingly, the electronic game controller 4 randomly selects three adjacent symbols in the associated reel strip to display in the respective symbol positions 13 of the reel 12. Another way to implement the random determination of the game symbols 10 to be displayed for the electronic game controller 4 to internally generate a random number and check if it is a predetermined number or within a predetermined range of numbers that will initiate the appearance of a game symbol of a particular type. For example, the predetermined range of numbers for a particular symbol (such as a substitute symbol 10e) could be the range of numbers between 1 and 10 and the electronic game controller 4 internally generates a random number between 1 and 100. Other game symbols 10 can be associated with different ranges (such as numbers 11 to 30 for an Ace symbol 10a, 31 to 55 for a picture symbol 10b, and so on up to 100). If the randomly generated number is any one of numbers 1 to 10, then this results in the electronic game controller 4 causing the substitute symbol 10e to appear in the symbol position 13 of the reel 12. If the randomly generated number is any one of numbers falling within another one of the ranges, the associated game symbol 10 is then selected by the electronic game controller 4 to be displayed in the symbol position 13. This process is then repeated for each symbol position 13 of the reels 12.

After the reels 12 stop spinning (and thus ends the spin or play of the base game 8), the electronic game controller 4 determines whether there are any predetermined winning combinations of the game symbols 10 appearing in any player-selected pay lines 14, such as a two of a kind, three of a kind, four of a kind or five of a kind for all the game symbols 10 and other combinations of a “full house”, “straight” or “flush” for the playing card game symbols 10a. It will be appreciated that other winning combinations of game symbols 10 can also be provided. If so, the gaming machine 1 enters a winning game state and awards a prize according to the displayed predetermined winning combination.

The electronic game controller 4 also determines whether the feature game 9 should be activated, based on a predetermined feature game trigger event, such as the appearance of a number of trigger symbols appearing in a play or spin of the base game 8. The appearance of the trigger symbols may be randomly determined by the electronic game controller 4 in the same manner as described above; i.e. by internally generating a random number and seeing if it falls within a predetermined range of numbers associated with the trigger symbol. In this embodiment, the feature game trigger event is the appearance of three scatter symbols 10d. The scatter symbols 10d need not appear on the same pay line 14, but can appear on any of the player-selected pay lines, as best shown in FIG. 3.

The feature game 9 as shown in FIG. 3 is an enhanced version of the base game 8. It uses the same game symbols 10 as the base game 8, as well as the same array 11, reels 12, game positions 13 and player-selectable pay lines 14 on the video screen 7. In the feature game 9, ten free plays or spins of the feature game are awarded to the player without having to make an additional bet or wager. It will be understood by those skilled in the art that a free play or spin involves a play of the game without requiring any bet to be made by the player, and that any number of free spins can be chosen for the feature game 9. In addition, it will be appreciated that in the art free spins are commonly referred to as “free games”. The number of free games remaining in the feature game 9 is indicated by a counter. Typically, the prizes awarded for the same winning combinations of game symbols in the feature game 9 are of higher value than the prizes awarded in the base game 8.

The feature game 9 operates in a similar manner to the base game 8, where the reels 12 visibly rotate and display randomly selected game symbols 10 in each game position 13 as described above. Predetermined winning combinations of randomly selected game symbols 10 in the array of the feature game 9 also result in the award of prizes to the player, usually of an enhanced value compared to the prizes awarded in the base game 8.

In the embodiment of FIG. 4, the various visual elements of the base game 8, such as standard game information like the number of pay lines available 15, the number of player-selected pay lines 16, the amount of player credits 17, the amount of the current bet wagered by the player 18, message area 20 and current denomination button 21, have been removed for clarity purposes. However, the base game 8 has the same or similar features of the base game 8 of FIG. 3, such as reels 12a to 12e, symbol positions 13 and pay lines 14a, 14c, 14d.

The base game 8 of FIG. 4 also has bonus symbol positions 30, indicated by a ring 33, that are designated by the electronic game controller 4 randomly across the array 11 based on a probability associated with each reel 12a to 12e that is discussed in more detail below. In some embodiments, the ring 33 may take the form of a coloured “spot” that is translucent so that the game symbol 10 is still visible to the player. In other embodiments, the ring 33 may take the form of a boundary defining the bonus symbol position 30. It will be appreciated that other ways in which the bonus symbol position 30 can be indicated are possible.

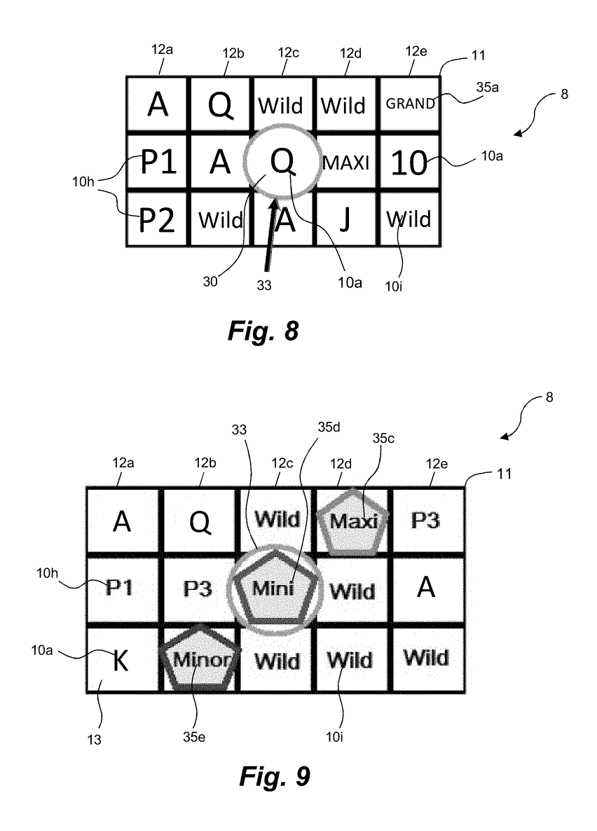

In this embodiment, five bonus symbol positions 30 are always designated for each play or spin of the base game 8. However, in other embodiments, the number of bonus symbol positions 30 that are designated may vary in number between spins. In one particular embodiment discussed below in relation to FIGS. 8 to 10F, the number of designated bonus symbol positions 30 depends on the bet made by the player to play the game 8.

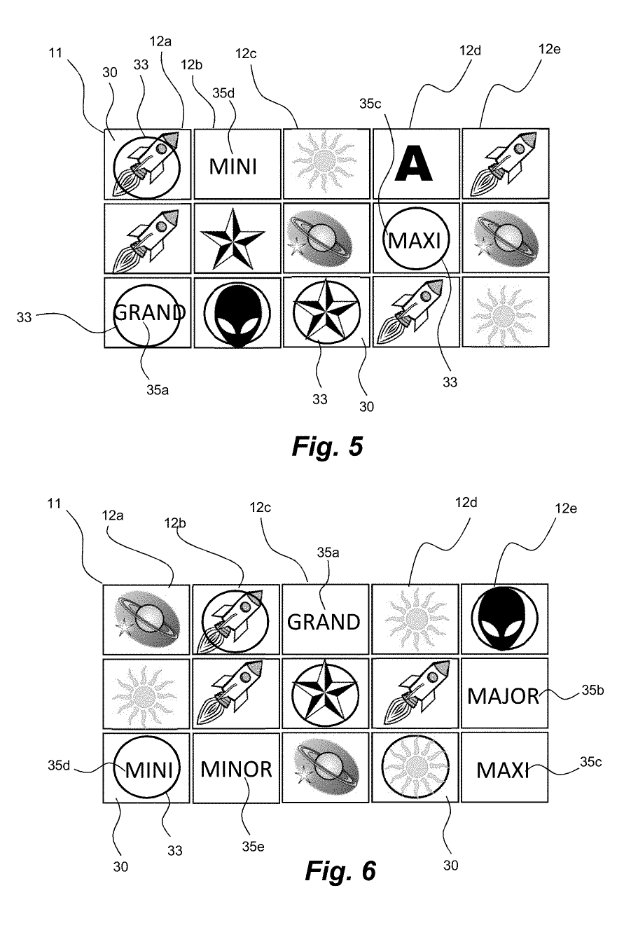

In any spin of the game 8, the bonus symbol positions 30 are designated at any five of the symbol positions on the reels 12a to 12e, including on the same reel, as illustrated in FIG. 5. In addition, the bonus symbol positions 30 move after each spin, as shown by the change in their locations on the reels 12a to 12e from FIG. 5 to FIG. 6. In other embodiments, the bonus symbol positions 30 may be restricted so that only one bonus symbol position can appear on a reel. That is, the bonus symbol positions 30 may only appear once in each reel, as illustrated for example in FIG. 6.

The game symbols 10f. 10g are then randomly selected for display in the symbol positions 13, including the bonus symbol positions 30, on the reels 12a to 12e in the same manner as described above. In some embodiments, the game symbols 10f, 10g are initially selected and displayed prior to designation of the bonus symbol positions 30. The electronic game controller 4 also determines whether to display a bonus symbol 35a to 35e in any of the symbol positions 13 and bonus symbol positions 30. In some embodiments, the electronic game controller 4 only determines whether to display a bonus symbol 35a to 35e in the designated bonus symbol positions 30 and not the symbol positions 13. The bonus symbols 35a to 35e in this embodiment comprise different types of jackpot symbols, each type being associated with a particular jackpot. The GRAND jackpot symbol 35a is associated with a grand jackpot; the MAJOR jackpot symbol 35b is associated with a major jackpot; the MAXI jackpot symbol 35c is associated with a maxi jackpot; the MINI jackpot symbol 35d is associated with a mini jackpot; and the MINOR jackpot symbol 35e is associated with a minor jackpot. The grand, major and maxi jackpots are all progressive jackpot prizes, whereas the mini and minor jackpots are credit or monetary bonus prizes having a fixed amount. Of course, the types of jackpot prizes can be varied, as desired, such as providing all five jackpot types as progressive jackpots.

A progressive jackpot prize takes a portion of each bet (typically a set percentage of each bet) made on the gaming machine and thus the amount of the progressive jackpot incrementally increases as more bets are made on the gaming machine 1. The progressive jackpot is typically awarded when a winning game combination associated with the jackpot occurs in the game played on the gaming machine. In many cases, progressive jackpots are associated with the least probable winning combination and are commonly the highest paying award of the gaming machine. In other cases, a separate trigger event can be used to award the progressive jackpot prize, such as a special jackpot symbol, a trigger event internally generated by the electronic game controller. Alternatively, or additionally, once a certain threshold is met, either a certain amount that has been bet on the gaming machine or the incremented amount of the progressive jackpot, a trigger event is activated in the electronic gaming machine to pay out the progressive jackpot prize. Progressive jackpot prizes also tend to be shared amongst multiple gaming machines so as to increase the amount of the progressive jackpot prize and hence increase player interest in playing one of the electronic gaming machines. In some gaming machines, more than one jackpot or progressive jackpot are offered by the gaming machine or gaming machines linked together.

Progressive jackpots can be confined to the gaming machine 1 as so called “standalone” progressive jackpots. Alternatively, the jackpot is a wide area or an in-house linked progressive jackpot prize. In other embodiments, one or more the progressive jackpot prizes are configured to be part of a wide area or in-house linked progressive jackpot prize. In other words, the progressive jackpot prizes can be awarded on a group of networked gaming machines in a specified area or a group of specified gaming machines that are linked together for jackpot purposes (usually via a central jackpot controller). The jackpot prizes can also be shared with any other games offered on the same gaming machine 1 (as in multi-game gaming machines).

Where a jackpot symbol 35a to 35e appears in a bonus symbol position 30, the player is awarded the jackpot associated with that jackpot symbol. For example, in FIG. 5, the GRAND jackpot symbol 35a has appeared in one bonus symbol position 30, as indicated by ring 33, on the reel 12a and the MAXI jackpot symbol 35c has appeared in one bonus symbol position 30, as indicated by ring 33, on the reel 12d. Hence, the player is awarded both the grand progressive and the maxi progressive jackpots associated with the GRAND and MAXI jackpot symbols 35a, 35c, respectively. Similarly, in FIG. 6, only the MINI jackpot symbol 35d has appeared in a bonus symbol position 30 on reel 12a, and so the player is awarded the mini jackpot associated with the MINI jackpot symbol. Where two or more of the same jackpot symbols 35a to 35e appear in two or more bonus symbol positions 30, the associated jackpot awarded to the player is multiplied by the number of jackpot symbols in the bonus symbol positions. Thus, each jackpot symbol 35a to 35e representing its jackpot or bonus prize that can be won multiple times.

The designation of the bonus symbol positions 30 by the electronic game controller 4 for any particular reel 12a to 12e depends on the probability of a bonus symbol 35a to 35e of any type appearing in one of the symbol positions 13 of that reel that is predefined in the programme instructions for the feature game 9 stored in the RAM of the electronic game controller 4. In some embodiments, the probability of a symbol position 13 being designated as a bonus symbol position 30 in a reel 12a to 12e is less than the probability of a bonus symbol appearing in the reel. For example, if there is a 70% chance of a bonus symbol 35a to 35e appearing on reel 12b, then the probability of a bonus symbol position 30 being designated on reel 12b is 30%. In other embodiments, the probability of a symbol position 13 being designated as a bonus symbol position 30 in a reel 12a to 12e is proportional to the probability of a bonus symbol appearing in the reel. For example, if there is a 30% chance of a bonus symbol 35a to 35e appearing on reel 12b, then the probability of a bonus symbol position 30 being designated on reel 12b is 60%. In further embodiments, the probability of a symbol position 13 being designated as a bonus symbol position 30 in a reel 12a to 12e is greater or higher than the probability of a bonus symbol appearing in the reel. For example, if there is a 40% chance of a bonus symbol 35a to 35e appearing on reel 12b, then the probability of a bonus symbol position 30 being designated on reel 12b is 60%. It will be appreciated that the probabilities and their relationship to each other may be varied as required to meet the desired game design.

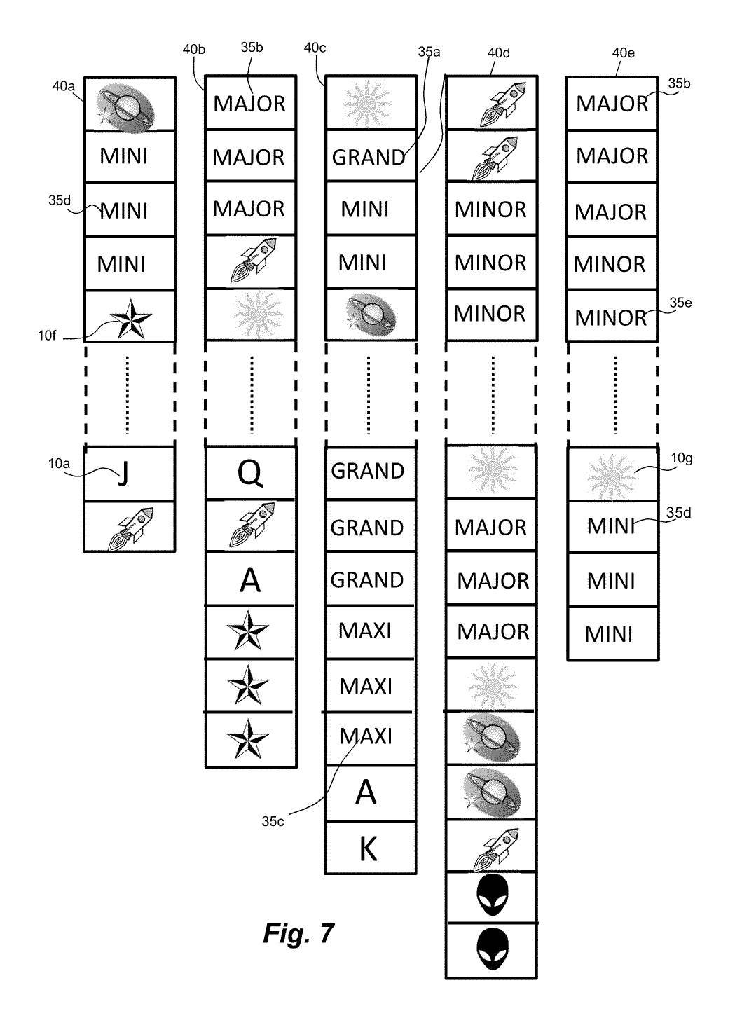

The probability of the bonus symbols 35a to 35e appearing on any one reel 12a to 12e can be controlled by the allocation of reel strips for each reel by the electronic game controller 4. Referring to FIG. 7, a number of reel strips 40a to 40e are shown, each reel strip having different game symbols 10a, 10f, 10g and bonus symbols 35a to 35e and different lengths. The number of bonus symbols 35a to 35e varies with each reel strip 40a to 40e. Hence, the frequency in which the bonus symbols 35a to 35e can be displayed in each reel 12a to 12e is controlled by choosing different reel strips 40a to 40e for each reel. Thus, the electronic game controller 4 can select a reel strip 40a to 40e that matches the desired probability for displaying a bonus symbol 35a to 35e relative to the probability for designating a bonus symbol position 30 for that reel 12a to 12e. For example, if the probability for displaying a bonus symbol is to be low for a reel 12a to 12e, then reel strip 40b could be chosen as it has a small number of jackpot symbols (being three MAJOR jackpot symbols 35b) compared to the total number of game symbols while being a relatively longer strip than, say, reel strip 40a, which also has a small number of jackpot symbols (being three MINI jackpot symbols 35d) but a smaller number of game symbols due to its shorter length.

In this embodiment, the amount of the bet made by the player influences the selection of the reel strip 40a to 40e for the reels 12a to 12e. In this case, the electronic game controller 4 will select reel strips 40a to 40e having more bonus symbols 35a to 35e and/or bonus symbols awarding jackpots of higher value (like the progressive jackpots associated with bonus symbols 35a to 35c) as opposed to jackpots of lower value (like the bonus prizes associated with bonus symbols 35d, 35e), as the bet made by the player increases. This means that the frequency of winning bonus prize(s) with the bonus symbols and the amount of those bonus prize(s) increases with an increase in the player bet. Thus, higher bets will reward the player with a higher chance of winning a jackpot by increasing the probability of a bonus symbol 35a to 35e appearing and of winning a higher value jackpot by increasing the probability of a bonus symbol 35a to 35c associated with a higher value jackpot.

This allocation or selection of an appropriate reel strip 40a to 40e may be applied for each reel 12a to 12e so that each reel is associated with each of the reel strips. In other embodiments, one or more reel strips may be associated exclusively with one or more reels. For example, reel strip 40e having a greater number of jackpot symbols 35a to 35e may only be available for selection for reels 12b and 12e. Similarly, reel strip 40c having the GRAND jackpot symbol 35a may be reserved only for reel 12c. In one further embodiment, only one reel strip 40a to 40e is associated with one reel 12a to 12c. In another embodiment, there is some overlap in which reel strips 40a to 40c may be shared by one or more reels 12a to 12e, but at least one reel can use a reel strip that another reel cannot. In yet another embodiment, the same reel strip can be used more than once by two reels in a spin of the game. A further embodiment ensures that at least one reel uses a different reel strip to another reel. An additional embodiment provides that each reel uses a different reel strip. It will be appreciated that while five reel strips 40a to 40e have been illustrated in FIG. 7, a lesser number or greater number of reels strips may be used for the reels 12a to 12e.

In the embodiment, the lower probability for a bonus symbol position 30 being designated on a reel 12a to 12e balances out the higher probability of a bonus symbol 35a to 35e appearing on the reel. However, in other embodiments the relative probabilities of designating the bonus symbol position 30 and the appearance of a bonus symbol 35a to 35e appearing on a particular reel can be varied as desired to meet a required game design. In this way, the game designer is able to control the volatility of the gaming machine 1. It will be appreciated that one skilled in the art will recognise that the term “volatility” refers to the expected frequency of winning game events occurring and the corresponding amount paid for each winning game event in order to maintain the required payout level set for the gaming machine. Thus, the amount paid for each winning combination and the level of return to the player determines the “volatility” of the gaming machine. For example, a gaming machine with low volatility is configured to have a relatively high frequency of “wins”, where each win has a relatively low value. Conversely, high volatility refers to a lower frequency of “wins” of correspondingly higher value. Throughout the specification, “volatility” is a reference to this characteristic of a gaming machine.

In some embodiments, the symbol positions 13 are not arranged into reels 12a to 12e, but in other predefined groups of symbol positions. For example, the symbol positions 13 can be grouped according to rows of the array 11 instead of columns defining the reels 12a to 12e. Where there is an uneven number of rows and columns, the symbols positions 13 may be grouped based on a shape of the array 11. For example, in an array having two columns with only two rows to form a sub-array and three columns with three rows forming another sub-array, the symbol positions 13 of the two by two sub-array can be grouped together as one predefined group while the symbol positions 13 of the three by three sub-array can be grouped together as another predefined group.

A further embodiment of the present disclosure is illustrated by FIGS. 8 to 10F, where the game symbols include playing card symbols 10a, picture P1, P2, P3 symbols 10h and WILD substitute symbols 10i. This embodiment works in a similar fashion as previously described above. That is, when a jackpot symbol 35a to 35e appears in the bonus symbol position 30, the associated jackpot is awarded to the player. As shown in FIG. 9, a Mini jackpot symbol 35d has appeared in the bonus symbol position 30 and so the associated mini jackpot is awarded to the player. The Maxi and Minor jackpot symbols 35c, 35e have not appeared in a bonus symbol position 13 and so these jackpots are not awarded to the player.

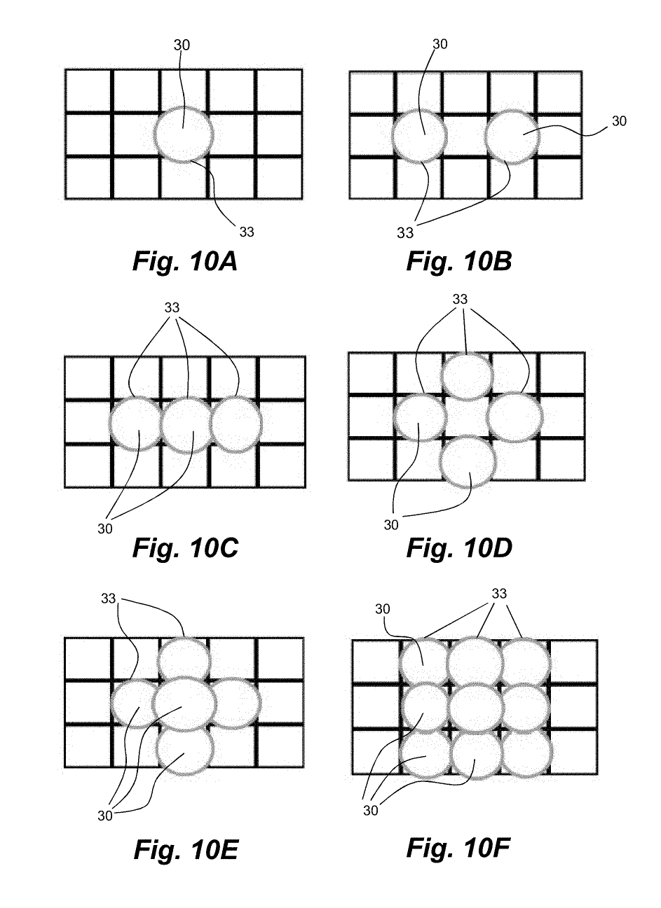

However, in this embodiment, the electronic game controller 4 designates a number of symbol positions 13 as bonus symbol positions 30 based on the bet made by the player to play the game 8, instead of the probability of one of the bonus symbols 35a to 35e appearing on reel 12a to 12e the symbol position belongs to. As shown in FIGS. 8 and 10A, a base bet or bet option BET 1 of 50 credits causes the designation of one bonus symbol position 30 on the array 11. As the player bet increases from bet options BET 2, BET 3, BET 4, BET 5 and up to BET 9, the number of designated bonus symbol positions 30 increase from two (FIG. 100B), three (FIG. 10C), four (FIG. 10D), five (FIG. 10E) and up to nine (FIG. 10F), respectively. The number of bonus symbol positions 30 corresponds to the bet option or level, which in this case is a multiple of the base bet of 50 credits. Hence, bet option BET 5 would be five times bet option BET 1 at 250 credits, while bet option BET 9 would be nine times bet option BET 1 at 450 credits. It will be appreciated that it is not necessary for such a correspondence to apply between the number of bonus symbol positions 30 and the amount of the bet as a multiplier of a base bet. Instead, a set of bet levels or options will be associated with a preset number of bonus symbol positions 30. Also, the increase in bonus symbol positions 30 need not increment by one, but there can be stepwise increases, such as from two bonus symbol positions to five bonus symbol positions and then to eight bonus symbol position as the amount of the bet increases.

In this embodiment, the same symbol positions 13 are designated as bonus symbol positions 30 for each bet option or level chosen by the player for familiarity and convenience. For example, the same four symbol positions are selected as bonus symbol positions 30 whenever a player chooses bet option BET 4. Alternatively, the bonus symbol positions 30 are arranged in a set pattern anywhere on the array 11. For example, four bonus symbol positions are always shown in a “cross” pattern as illustrated in 10D, but may not necessarily be centrally located. However, in other embodiments, the bonus symbol positions 30 may be randomly determined or even selected by the player through a touch screen interface or buttons on the console.

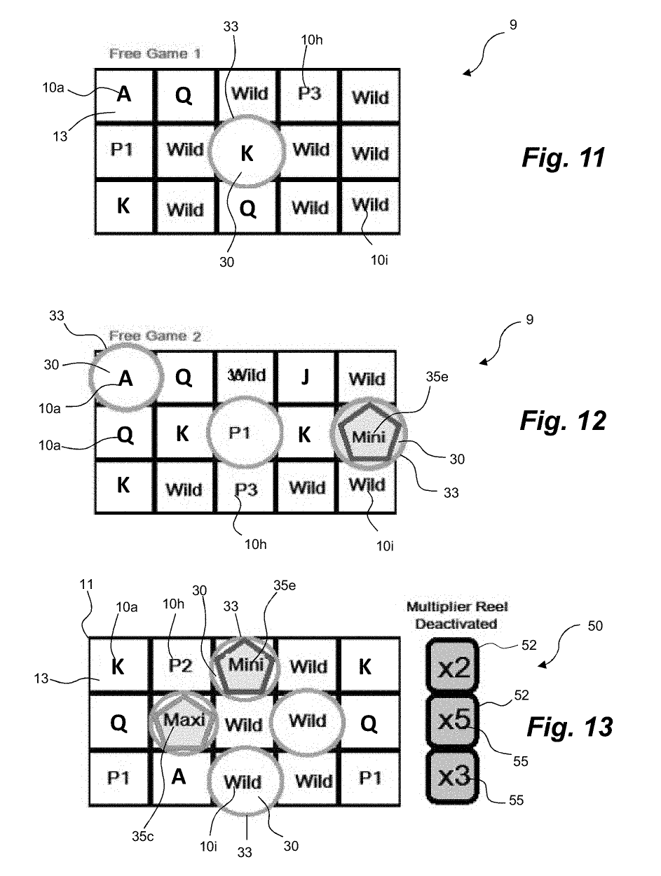

A further embodiment of the disclosure is illustrated in FIGS. 11 and 12, where the designation of bonus symbol positions 30 occurs in a feature game 9. In this embodiment, the player is able to collect or accumulate bonus symbol positions 30 after each free game or spin, thereby increasing the chances of winning a jackpot during the feature game 9. In the initial free game shown in FIG. 11, one bonus symbol position 30 is designated (based on a BET 1 bet option being played in the base game 8 that triggered the feature game 9), but no jackpot is awarded as no bonus symbol has appeared in the bonus symbol position 30. In the next free game shown in FIG. 12, two additional bonus symbol positions 30 have been designated and a Mini jackpot symbol 35d has appeared in one of the added bonus symbol positions, awarding the mini jackpot to the player. In this embodiment, the addition of one or more bonus symbol positions is randomly determined by the electronic game controller 4. In other embodiments, the number of bonus symbol positions 30 added after each free spin may depend on the amount of the bet made in the base game 8. In this case, more bonus symbol positions 30 are added after each free spin as the bet made to play the base game 8 increases.

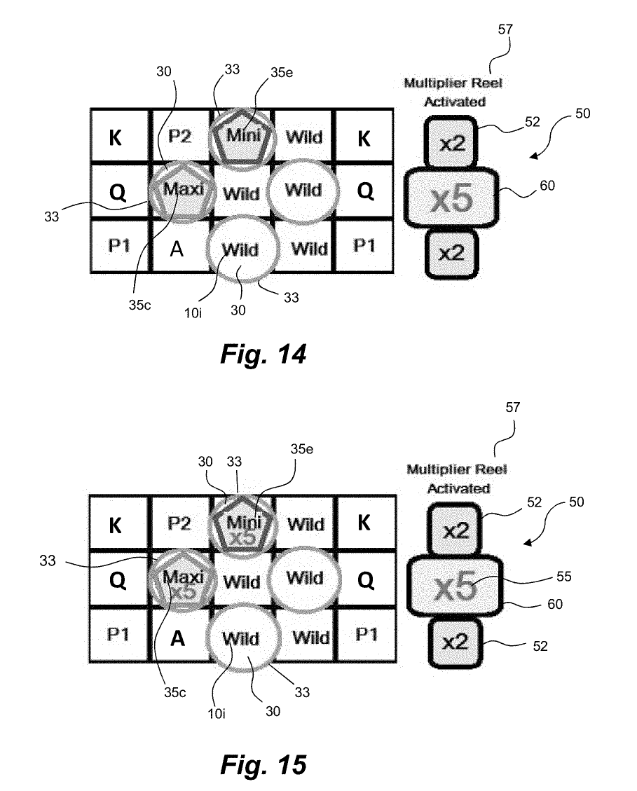

Yet another embodiment of the disclosure is illustrated in FIGS. 13 to 15, where the feature game 9 includes a multiplier reel 50 is provided adjacent to the array 11 having a number of symbol positions 52 for displaying different multiplier symbols 55. A message 57 indicates that the multiplier reel 50 is currently inactive, as best shown in FIG. 13. When a bonus symbol 35a to 35e appears in a bonus symbol position 30 (the Mini and Maxi jackpot symbols 35d, 35c have appeared in bonus symbol positions 30 shown in FIGS. 13 and 14), the multiplier reel 50 is activated to spin, as best shown in FIG. 14. Once the multiplier reel 50 stops, as best shown in FIG. 15, the middle symbol position 60 (and the displayed ×5 multiplier symbol 52) expands in size to indicate that an ×5 multiplier has been awarded for the won jackpots. In this case, the mini and maxi jackpots are each multiplied by five; in effect, the mini and maxi jackpots are each awarded five times to the player. Therefore, it can be seen that the multiplier reel 50 enhances the amount of the jackpots that can be won in the feature game 9.

In another embodiment, the multiplier reel 50 is only made available upon payment of an ante bet by the player in the base game 8. Hence, once the feature game 9 is triggered, then the multiplier reel 50 will be immediately activated and does not require activation through the appearance of a bonus symbol 35a to 35e in a bonus symbol position 30. In further embodiments, the range of multipliers in the multiplier reel 50 may be randomly selected by the electronic game controller 4 and/or may vary depending on the bet made by the player to play the base game 8. For example, a bet of 50¢ may only provide a range of multipliers from ×2, ×3 and ×5, whereas a bet of $1 may provide a range of multipliers from ×3, ×5 and ×8 and a bet of $2 may provide a range of multipliers from ×5, ×8 and ×10.

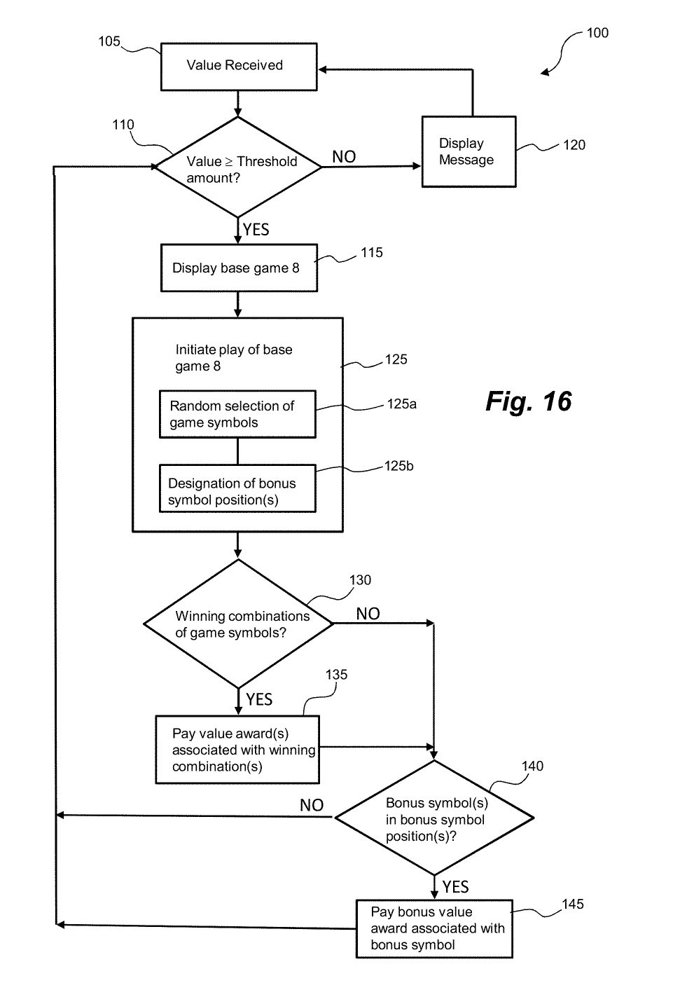

FIG. 16 illustrates an overview of the process or method 100 in which the electronic game controller 4 operates according to embodiments of the disclosure. At block 105, the value transfer mechanism, such as vending slots 5, receives value from the player to play the base game 8 on the electronic gaming machine 1 and transmits the amount of the value received to the electronic game controller 4. A determination is made at block 110 by the electronic game controller 4 as to whether sufficient value has been received at or above the threshold amount to initiate play of the base game 8. If so, then the electronic game controller 4 at block 115 transmits a signal to the video display screen 7 to display the base game 8 based on the programme instructions stored in the memory of the electronic game controller 4. If not, the electronic game controller 4 at block 120 transmits a signal to the video display screen 7 to display a message advising that more value is required before the base game 8 can be played.

At block 125, the electronic game controller 4 initiates a play or spin of the base game 8 by randomly selecting game symbols 10 to be displayed on the reels 12 (including bonus symbols 35) at sub-block 125a and designating one or more bonus symbol positions 30 at sub-block 125b. As discussed above, the designation of the bonus symbol positions 30 is based on either the probability assigned to the symbol positions 13 (such as the embodiment of FIG. 4) or randomly determined (such as the embodiment of FIG. 13). At block 130, the electronic game controller 4 determines whether there are any winning combinations of game symbols 10 displayed on the reels 12. If so, then the electronic game controller 4 at block 135 pays the value awards associated with those winning combinations to the player and then proceeds to block 140. If not, then the electronic game controller 4 directly proceeds to block 140. At block 140, the electronic game controller 4 determines whether a bonus symbol 35 has appeared in any of the bonus symbol positions 30. If so, then at block 145, the electronic game controller 4 awards the bonus value award (such as a jackpot) associated with the bonus symbol 35 and ends this instance or play of the base game 8. If not, the play of the base game 8 also ends. The electronic game controller 4 then returns to block 105 to assess if there is sufficient value for another play of the base game 8.

It will be appreciated that other steps may occur in the described method. For example, a further decision block may be added after blocks 140, 145 so that the electronic game controller 4 may assess whether any associated feature game 9 has been triggered in the play of the base game 8. Also, it will be appreciated that blocks 130, 135 and 140, 145 may be swapped so that the determination of whether a bonus value award has been won occurs prior to determination of whether any value awards for winning combinations of game symbols has been won.

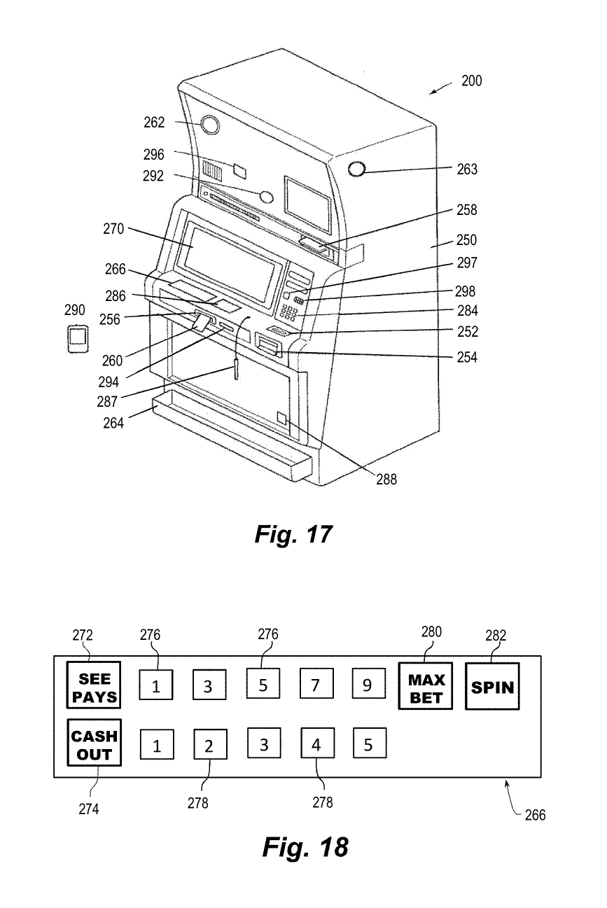

Referring to FIG. 17, another embodiment is shown in the form of an electronic gaming machine 200. The electronic gaming machine 200 may include a housing or cabinet 250 and one or more value transfer mechanisms or devices, which may include a coin slot or acceptor 252, a paper currency or bill acceptor 254, a ticket reader/printer 256 and a card reader 258, which may be used to input value to the electronic gaming machine 200. A value transfer device may include any device that can accept value from a player. The topper may be mounted to the top of the electronic gaming machine 200.

If provided on the electronic gaming machine 200, the ticket reader/printer 256 may be used to read and/or print or otherwise encode ticket vouchers 260. The ticket vouchers 260 may be composed of paper or another printable or encodable material and may have one or more of the following informational items printed or encoded thereon: the casino name, the type of ticket voucher, a validation number, a bar code with control and/or security data, the date and time of issuance of the ticket voucher, redemption instructions and restrictions, a description of an award, and any other information that may be necessary or desirable. Different types of ticket vouchers 260 could be used, such as bonus ticket vouchers, cash-redemption ticket vouchers, casino chip ticket vouchers, extra game play ticket vouchers, merchandise ticket vouchers, restaurant ticket vouchers, show ticket vouchers, etc. The ticket vouchers 260 could be printed with an optically readable material such as ink, or data on the ticket vouchers 260 could be magnetically encoded. The ticket reader/printer 256 may be provided with the ability to both read and print ticket vouchers 260, or it may be provided with the ability to only read or only print or encode ticket vouchers 260. In the latter case, for example, some of the electronic gaming machines 200 may have ticket printers 256 that may be used to print ticket vouchers 260, which could then be used by a player in other electronic gaming machines 200 that have ticket readers 256.

If provided, the card reader 258 may include any type of card reading device, such as a magnetic card reader or an optical card reader, and may be used to read data from a card offered by a player, such as a credit card or a player tracking card. If provided for player tracking purposes, the card reader 258 may be used to read data from, and/or write data to, player tracking cards that are capable of storing data representing the identity of a player, the identity of a casino, the player's gaming habits, etc.

The electronic gaming machine 200 may include one or more audio speakers 262, a coin payout tray 264, an input control panel 266, and a colour video display unit 270 for displaying images relating to the game or games provided by the electronic gaming machine 200. The audio speakers 262 may generate audio representing sounds such as the noise of spinning reels, a dealer's voice, music, announcements or any other audio related to a game. The input control panel 266 may be provided with a plurality of pushbuttons or touch-sensitive areas that may be pressed by a player to select games, make wagers, make gaming decisions, etc.

FIG. 18 illustrates one possible embodiment of the control panel 266, which may be used where the electronic gaming machine 200 having a plurality of reels. The control panel 266 may include a “See Pays” button 272 that, when activated, causes the display unit 270 to generate one or more display screens showing the odds or payout information for the game or games provided by the electronic gaming machine 200. As used herein, the term “button” is intended to encompass any device that allows a player to make an input, such as an input device that must be depressed to make an input selection or a display area that a player may simply touch. The control panel 266 may include a “Cash Out” button 274 that may be activated when a player decides to terminate play on the electronic gaming machine 200, in which case the electronic gaming machine 200 may return value to the player, such as by returning a number of coins to the player via the payout tray 264.

The control panel 266 may be provided with a plurality of selection buttons 276, each of which allows the player to select a different number of pay lines prior to spinning the reels. For example, five buttons 276 may be provided, each of which may allow a player to select one, three, five, seven or nine pay lines.

The control panel 266 may also be provided with a plurality of selection buttons 78 each of which allows a player to specify a wager amount for each pay line selected. For example, the electronic gaming machine 200 may be provided with five selection buttons 78, each of which may allow a player to select 1¢, 2¢, 5¢, 10¢ and 20¢, to wager for each pay line selected. In that case, if a player were to activate one of the buttons 276 to select five pay lines and then activate one of the buttons 278 to select 5¢ per pay line to be wagered or bet, the total wager would be $0.25.

The control panel 266 may include a “Max Bet” button 280 to allow a player to make the maximum wager allowable for a game. In the above example, where up to nine pay lines were provided and up to 200 could be wagered for each pay line selected, the maximum wager would be $1.80 The control panel 266 may include a spin button 282 to allow the player to initiate spinning of the reels after a bet has been made.

In FIG. 18, a rectangle is shown around the buttons 272, 274, 276, 278, 280, 282. It should be understood that the rectangle simply designates, for ease of reference, an area in which the buttons 272, 274, 276, 278, 280, 282 may be located. Consequently, the term “control panel” should not be construed to imply that a panel or plate separate from the housing 250 of the electronic gaming machine 200 is required, and the term “control panel” may encompass a plurality or grouping of player activatable buttons.

Although one possible control panel 266 is described above, it should be understood that different buttons could be utilized in the control panel 266, and that the particular buttons used may depend on the game or games that could be played on the electronic gaming machine 200. Although the control panel 266 is shown to be separate from the display unit 270, it should be understood that the control panel 266 could be generated by the display unit 270. In that case, each of the buttons of the control panel 266 could be a coloured area generated by the display unit 270, and some type of mechanism may be associated with the display unit 270 to detect when each of the buttons was touched, such as a touch-sensitive screen.

As noted above, the electronic gaming machine 200 may include a mechanism by which the electronic gaming machine 200 may determine the identity of the player. In particular, the card reader 258 may be used to read a card that carries an identification code that may be uniquely associated with the player so that the gaming unit can differentiate that player from all other players, or so that the gaming unit can differentiate that player as a member of a group of players from all player not a member of the group of players. The electronic gaming machine 200 may also include equipment, such as a keypad 284, an input pad 286 (with optional stylus 287), a port (or antenna) 288 adapted to communicate via a wired or wireless link (infrared or radio frequency link, for example) to a mobile electronic device 290 (such as a personal digital assistant, smart phone or tablet), a camera 292, a scanner 294, a retinal (or iris) scanner 296, fingerprint scanner 297, and/or a microphone 298. The electronic gaming machine 200 may include any one of the devices 258, 284, 286, 288, 290, 292, 294, 296, 297, 298, or the electronic gaming machine 200 may include a combination of some or all of the devices 258, 284, 286, 287, 288, 290, 292, 294, 296, 297, 298.

In operation, a player may identify him or herself to the electronic gaming machine 200 by entering a unique numeric or alpha-numeric code using the key pad 284, for example. Alternatively, the player may use his or her finger or the stylus 287 to sign his or her signature on the input pad 286. As a further alternative, the player may sign his or her signature on the mobile electronic device 290, which signature is then converted to electronic data, and the data is then transferred via the port/antenna 288 to the electronic gaming machine 200. As yet another alternative, the player may sign his or her signature on a piece of paper that is then photographed using the camera 292 or scanned using the scanner 294 (or the bill acceptor 254) to convert the signature into electronic data. As an additional alternative, the player may place one of his or her fingers or his or her hand on the scanner 297, and the scanner 297 may generate an electronic data representation of the fingerprint on one or more of the player's fingers or an electronic data representation of the pattern of the entire hand. Alternatively, the camera 292 may be used to take a picture (live or still) of the player, the picture then being converted into electronic data. As a still further alternative, the player may place his or her eye up to the retinal (or iris) scanner 296, and the retinal (or iris) scanner 296 may generate an electronic data representation corresponding to the pattern of the retina (or iris) of the player. As yet another alternative, the player may speak into the microphone 298, and characteristics of the spoken words (or voiceprint) may be converted into an electronic data representation.

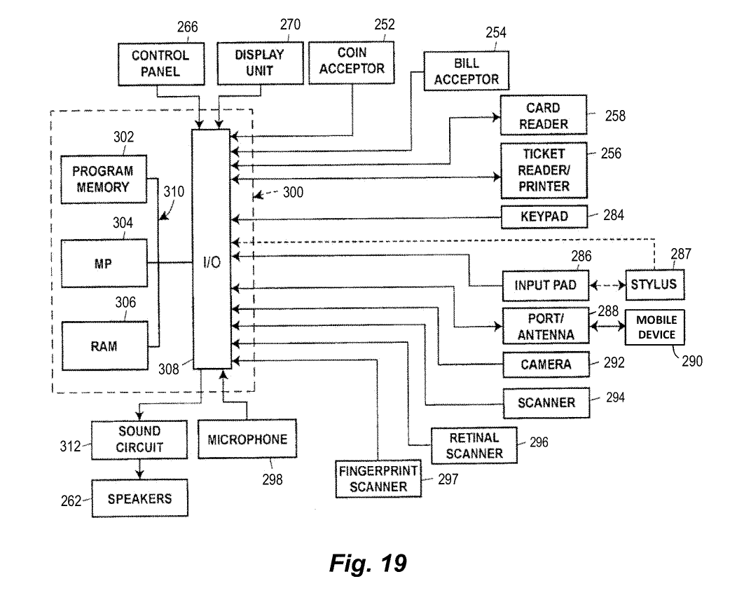

FIG. 19 is a block diagram of a number of components that may be incorporated in the electronic gaming machine 200. Referring to FIG. 19, the electronic gaming machine 200 may include a controller 300 that may comprise a program memory 302, a microcontroller or microprocessor (MP) 304, a random-access memory (RAM) 306 and an input/output (I/O) circuit 308, all of which may be interconnected via an address/data bus 310. It should be appreciated that although only one microprocessor 304 is shown, the controller 300 may include multiple microprocessors 304. Similarly, the memory of the controller 300 may include multiple RAMs 306 and multiple program memories 302. Although the I/O circuit 108 is shown as a single block, it should be appreciated that the I/O circuit 308 may include a number of different types of I/O circuits.

The RAM(s) 304 and program memories 302 may be implemented as semiconductor memories, magnetically readable memories, and/or optically readable memories, for example.

FIG. 19 illustrates that the coin acceptor 252, the bill acceptor 254, the ticket reader/printer 256, the card reader 258, the control panel 266, the display unit 270, the keypad 284, the input pad 286 (and optionally the stylus 287), the port/antenna 288, the digital camera 292, the scanner 294, the retinal scanner 296, the fingerprint scanner 297 and the microphone 298 may be operatively coupled to the I/O circuit 308, each of those components being so coupled by either a unidirectional or bidirectional, single-line or multiple-line data link, which may depend on the design of the component that is used. The speaker(s) 262 may be operatively coupled to a sound circuit 312, that may comprise a voice- and sound-synthesis circuit or that may comprise a driver circuit. The sound-generating circuit 312 may be coupled to the I/O circuit 308.

As shown in FIG. 19, the components 252, 254, 256, 258, 266, 270, 284, 286, 287, 288, 292, 294, 296, 297, 298, 312 may be connected to the I/O circuit 308 via a respective direct line or conductor. Different connection schemes could be used. For example, one or more of the components shown in FIG. 18 may be connected to the I/O circuit 308 via a common bus or other data link that is shared by a number of components. Furthermore, some of the components may be directly connected to the microprocessor 304 without passing through the I/O circuit 308.

In some embodiments, at least one of the game symbols comprises a game enhancing symbol that confers a game enhancing element to the player. It is further preferred that the game enhancing element modifies the result of a play of the game, which can be any one or combination of the base game 8 and feature game. The game enhancing elements may provide different types of effects or modifications of the game play result. In one embodiment, the game enhancing element comprises the award of one or more plays of the game that do not require a bet from the player. In other words, the game enhancing element awards a predetermined number of “free” games. In some embodiments, the game enhancing element comprises at least one or more a win multiplier, wild multipliers, bonus wilds, symbols that cause the award of additional free games, trigger symbols to retrigger the at least two second arrays, held columns, random wild symbols, stacked symbols, bonus symbols, new game symbols, reveal symbols, progressives, bonus credits, jackpot symbols, and one or more symbol replacements. A variety of game enhancing elements can be awarded by the game enhancing symbols, including:
symbols that award a predetermined number of free plays of the game;
win multiplier symbols that multiply the amount of any win from one of the predetermined winning combinations;
“wild” symbols that cause the display of substitute symbols in randomly selected symbol positions;
bonus symbols that awards a bonus prize, either as a monetary amount or as a bonus credit;
wild multiplier symbols that cause the display of substitute symbols on the array 11 and multiplies the amount of any win from one of the predetermined winning combinations;
bonus wild symbols that cause the display of substitute symbols on the array 11 and awards a bonus prize;
symbols that cause the award of additional free plays of the game;
symbols that cause one or more of the symbol positions to be held static (typically one or more reels 12a to 12e) and display substitute symbols on the array 11;
symbols that cause the same game symbol to be stacked in a group of symbol positions, typically the group being one or more reels 12a to 12e;
symbols that cause the display of new game symbols on the array 11;
“reveal” symbols that cause a game symbol to reveal another game symbol; and
“replacement” symbols that cause one or more game symbols to be replaced by other game symbols in the array 11.

These game enhancing symbols do not modify the function or value of the game symbols 10 that appear on the arrays 11, but instead confer bonus prizes, free games or change existing game symbols for other game symbols (such as replacing picture, royal card or symbols belonging to a reel with wild/substitute symbols). Where the function of game symbols 10 have been changed or the game symbols 10 are replaced, then this modification can take effect with the next play of the game instead of applying to the result of the spun array 11. In another embodiment, the game enhancing symbols may indicate the duration in which its game enhancing element is applied, such as a predetermined number of spins or a predetermined time period.

It will be appreciated that in other embodiments, game enhancing elements can also be awarded as a separate aspect of the games 8, 9. The game enhancing elements may further be awarded in addition or as an alternative to the enhanced prizes awarded based on winning combinations of game symbols 10 in the games 8, 9. In a further embodiment, the award of game enhancing elements can be done by way of a sixth reel or the appearance of game enhancing symbols in the reels 12a to 12e. The sixth reel in this case is simply added as an extension to the array 11 and spins either game enhancing symbols or “blank” symbols.

In some embodiments, the game enhancing symbols include “collector”-type game enhancing symbols which award points or tokens. The collection of points or tokens during the base game 8 and/or feature game 9 leads to the trigger of additional prizes or game enhancing symbols, depending on the number of points or tokens that are collected. These additional prizes can include stand alone progressive jackpots, bonus prizes and super games, which are enhanced versions of free spins or games where there are greater pay outs or frequency of wins.

In other preferred forms, the game enhancing element can be an enhanced version of the array 11. The enhanced array may provide additional game enhancing symbols that include the award of points or an additional number of free spins of the array 11 (for example, retriggering 5 more free spins). The collection of points awarded by the enhanced array during free spins or game leads to the trigger of additional prizes or game enhancing symbols, depending on the number of points that are collected. These additional prizes can include stand alone progressive jackpots, bonus prizes and super games, which are enhanced versions of free spins or games where there are greater pay outs or frequency of wins. In addition, the enhanced array has a different visual representation to the array 11. In addition, the enhanced array may provide game enhancing symbols of greater value and/or frequency compared to the array 11.

Furthermore, the embodiments of the present disclosure have been described as providing a standard 5×3 array for the base game 8 and the feature game 9. However, it will be appreciated that in other embodiments, the size and shape of the base game array 11 and feature game array may vary as desired. For example, the arrays 11 could take any number of different shapes, such as triangular, circular, square, hexagonal, hemi-spherical or other polygonal shapes. For example, the base game array 11 could comprise a circular array having three rings (equivalent to rows) like a bullseye target segmented into five columns. The feature game array would then expand into additional rings surrounding the initial rings of the base game array 11. Alternatively, the arrays 11 could have an unequal number of rows or columns. For example, the reels 12a, 12b could have three rows, but the reels 12c to 12e could have four rows.

While the preferred embodiments have been described in relation to either a base game 8 or a feature game 9, those skilled in the art will appreciate that each of the embodiments can readily be applied to the base game alone, a feature game alone or a combination of both a base game and a feature game.

Another variation to the embodiment awards a free spin for each bonus symbol 35a to 35e displayed in a symbol position 13 and/or bonus symbol position 30 in the array 11. Thus, if the player completes the array 11, he or she would receive nine free spins. Thus, more generally additional plays of the game are awarded as the number of symbol positions 13 displaying the bonus symbol 35a to 35e increases. Where the player still has a number of free spins remaining when the array 11 is completed, and the remaining free spins are used for the following game. Alternatively, the game also ends when all fifteen symbol positions 13 are filled with the bonus symbol 35a to 35e.

In a further variation to the embodiments, each game or symbol position 13 comprises its own individual reel and three of the reels may be grouped into columns of reels. That is, each symbol position 13 has its own individual reel strip of game symbols.

In other embodiments, the gaming machine 1 also offers the player the opportunity to play in community games against other players in so-called tournament games, or even in player versus player games. This is typically implemented by electronically linking several gaming machines 1 in a group within a gaming venue. The player versus player or tournament game can be played simultaneously by the players or can be staggered, with some players playing at one time and some players playing at another time in the same game. In this situation, the player versus player or tournament game comprises the award of an additional bonus prize in addition to the jackpot prizes in the selected available jackpot set.

While the same game format is essentially used across the base game 8 and feature game 9, it will be appreciated that the game format may vary across the base and feature games, as well as between base games where more than one game is offered by the same electronic gaming machine 1. For example, one of the games 8 may be a wheel-type game or a four reel game and another of the games may be a standard five reel game. Similarly, the games 8 may each have different game symbols, game rules and pay tables that are unique to each game.

While one embodiment has been described in relation to a base game 8 and a feature game 9, it will be appreciated that the present disclosure could include one or more additional feature games that are triggered by specific trigger symbols appearing in the feature game 9. Also, the additional feature games may also have trigger symbols that trigger further feature games in a cascading fashion. These additional and further feature games could have the same game play elements as the feature game 9 or be different feature games entirely.

In other embodiments, the base game 8 and the feature game 9 need not be displayed alternately on a single video screen 7. Instead, they may be displayed on the same video screen 7, with the base game 8 shown in the lower playing area 7a and the feature game 9 shown in the upper display area of the video screen 7. Alternatively, the base game 8 and the feature game 9 are shown on separate video screens, with the base game 8 shown in a lower video screen corresponding to the lower playing area 7a and the feature game 9 shown in an upper video screen corresponding to the upper display area. Also, the order can be reversed, with the lower playing area 7a or video screen showing the feature game 9 and the upper video screen or upper playing area of a single video display screen 7 showing the base game 8.

In another embodiment, the video screen 7 is a touch screen for use in addition to the player-actuatable buttons 6 so as to enable the player to select the bet level (such as bet denominations or bet per pay line 14) as well as other various features, such as making monetary bets for the game, initiating play of any base and feature games played and responding to any messages or requests issued on the gaming machine 1 by the electronic game controller 4. In this case, the player may control when the reels 12 start spinning and stop spinning, either individually or collectively, by simply touching the reels 12. Control over spinning of the reels 12 can also be implemented through the buttons 6 on the console 3. This increases player interaction and provide the player with an opportunity to guess when a particular game symbol 10 may appear in the reels 12.

In some embodiments, in response to a feature game trigger event in the base game, the electronic controller causes the display to display game symbols for playing the feature game. Alternatively, the electronic controller causes the display of the feature game and the base game during play of the base game, the feature game being inactive until triggered. In this embodiment, the change in the feature game from being inactive to active may be indicated on the display. This indication may be visual, aural or a combination of both.

In some embodiments, the gaming machine comprises an input device for receiving commands from the player to play the game, wherein the input device comprises one or more buttons in electronic communication with the electronic controller to transmit the player commands to the electronic controller.

In some embodiments, the input device comprises one or more buttons on the housing, the buttons being in electronic communication with the electronic controller. In other embodiments, the buttons are arranged on a console of the housing. Alternatively or additionally, the input device comprises a touch sensitive surface on the display for receiving commands from the player, the touch sensitive surface being in electronic communication with the electronic game controller to transmit the player commands to the electronic controller.

In some embodiments, the gaming machine comprises a value transfer mechanism for receiving value from the player to make a bet and initiate a play of the game. In other embodiments, the value transfer mechanism also pays the prizes to the player using value in an amount equal to an awarded prize. It is further preferred that the housing comprises the value transfer mechanism. In one embodiment, the value transfer mechanism comprises one or more vending slots for paying and/or receiving value. In other embodiments, the value transfer mechanism comprises a value input/value output device. In further embodiments, the value transfer mechanism comprises a coin slot or acceptor, a paper currency acceptor, a ticket reader and/or printer or a card reader and/or writer.

In some embodiments, the game enhancing element comprises at least one or more of a predetermined number of free games, a win multiplier, wild multipliers, bonus wilds, symbols that cause the award of additional free games, trigger symbols to retrigger the at least two second arrays, held columns, random wild symbols, stacked symbols, bonus symbols, new game symbols, reveal symbols, progressives, bonus credits, jackpot symbols, and one or more symbol replacements.

In some embodiments, the base game and the feature game each comprises an array of rows and columns of the predetermined game positions, and the base game array is different in size and/or dimensions to the feature game array. In other embodiments, the feature game array is greater in size than the base game array. In one preferred form, the base array comprises three rows and five columns and the feature game array comprises either more than three rows or more than five columns. In a further preferred form, the feature game array is an extended base game array.

In some embodiments, a feature game trigger event occurs in the base game to trigger the feature game. In one embodiment, the feature game trigger event comprises a random event determined by the electronic game controller at the start of play of the feature game. In another embodiment, the feature game trigger event comprises the appearance of at least one trigger symbol in the base game array. In another alternative, the feature game trigger event comprises an in-game event during play of the base game.

In some embodiments, the array (including the base game array and/or the feature game array) take any one of a circular, triangular, oval, semi-circular, hexagonal, pentagonal, octagonal, non-rectangular or polygonal shape. In one preferred form, the wheels and the enhanced wheels arrays take the form of partially shown circular wheels.

In some embodiments, the player selectively starts and/or stops play of the base game array and/or the feature game array.

In some embodiments, the game symbols may be used to play a slots-type game. In other embodiments, the game symbols may be used to play a poker-type game. In further embodiments, the game symbols may be used to play a bingo or keno-type game

In some embodiments, the gaming machine comprises a mobile electronic gaming device. In other embodiments, the mobile electronic gaming device comprises a handheld electronic device. In one preferred form, the handheld electronic device comprises a handheld electronic gaming device or a smart phone. Alternatively, the gaming machine comprises a computer. In other embodiments, the computer is connected to a communication network.

It will be appreciated that while the preferred embodiments have been described in relation to an industry standard electronic gaming machine, the present disclosure can be readily applied to other types of electronic gaming machines, including a personal computer (standing alone or connected to a communications network, LAN or WAN), mobile electronic devices (such as handheld or portable electronic devices like tablets and smart phones) and other electronic devices capable of displaying a game. In the case of mobile electronic device, in one arrangement it may permit the player to make bets using “virtual” credits that represent a monetary value, but do not require the player to make a monetary transaction. Instead, the present disclosure may provide a tiered access to the various features of the game so that the player can make relatively small payments to access particular features of the game or obtain additional benefits during game play. An alternative arrangement would require the player to purchase virtual credits or tokens via an interface on the mobile electronic device or an online interface accessible by the mobile electronic device. Similarly, either of the above described arrangements can be applied where the present disclosure is implemented on a personal computer (PC) connected to the internet (wirelessly or not). In one example of the implementation, the PC would access an online casino over the internet to play the game of the present disclosure or the game of the present disclosure would be part of a social networking website. It is also contemplated that the player could also make regular payments to subscribe to continue playing the game on the mobile electronic device, PC or other electronic device.

In an alternative embodiment, the gaming machine also provides an option for the player to play with either credits based on a monetary amount or virtual credits as discussed above. This can be implemented by way of a selection menu prior to playing the selected game or by providing a suitable menu button on screen during play of the selected game.

In another aspect, the present disclosure includes a computer programme configured to perform the present disclosure. In this way the present disclosure can be implemented in various ways on a gaming machine. In a further aspect, the present disclosure includes a gaming system configured comprising a central processing unit (such as a computer or computational processor) configured for communication with a gaming machine to perform the present disclosure. In a yet another aspect, the present disclosure includes a non-transitory computer readable or carrier medium carrying computer executable code that, when executed on a central processing unit configured for communication with a gaming machine, causes the central processing unit to perform the present disclosure. In this case, the non-transitory carrier medium includes an external hard drive, a memory device, including a memory card, smart card, a radio frequency identification (RFID) device, USB key, magnetic card or other electronic storage device.

While the illustrated embodiments include an electronic display on which the array of game positions is displayed, it will be recognized that the disclosed embodiments could instead incorporate mechanical or electro-mechanical reels to define the array of game positions. In fact, to the extent that the game positions, game symbols or operation of the gaming machine described herein would require a modification of such mechanical or electro-mechanical reels, it will be recognized that the embodiment represents a change in the structure or operation of a machine, rather than simply a variation in the rules of playing a game. In addition or in the alternative, the variation in the game positions, game symbols or operation of the gaming machine described herein may be viewed as analogous to a method for utilizing a new game apparatus (like a new deck of cards), rather than simply as a new set of rules in and of themselves.

It will further be appreciated that any of the features in the preferred embodiments of the present disclosure can be combined together and are not necessarily applied in isolation from each other. For example, the feature of the player being able to selectively starting or stopping spinning of the reels 12 and the feature of providing separate video screens for the lower playing area 7a and upper display area can be combined into a single gaming machine 1. Similar combinations of two or more features from the above described embodiments or embodiments of the present disclosure can be readily made by one skilled in the art.

Hence, the embodiments of the present disclosure enable the gaming machine 1 to award additional bonus prizes to those that can be obtained from standard combinations of game symbols 10 displayed in the array 11. This increases the probability of the player winning a prize and/or a prize of higher amounts than is ordinarily possible. In addition, by providing bonus symbol positions 30 that in effect trigger the award of a bonus prize or jackpot upon the appearance of a bonus symbol, the player is able to readily determine the likelihood of winning a jackpot, instead of making an uninformed guess by the relative amounts shown in typical jackpot meters shown on the gaming machine 1. Accordingly, there is more transparency in the awarding jackpots on the gaming machine 1 and the player has greater control in determining the risk vs reward ratio when playing a game implementing embodiments of the present disclosure on the gaming machine. In this manner, the embodiments facilitate efficient use of the screen by providing more game information to the player than can be found in standard gaming machines. Moreover, the use of a bonus symbol position and bonus symbol arrangement enables the award of jackpots in a more entertaining manner to the player. The embodiments of the present disclosure also add greater value to a player in terms of the probability of winning a prize and providing greater variety in game play, especially compared to a conventional gaming machine that only has one set of reels and a single feature game. All these advantages of the present disclosure result in the player being more likely to retain interest in continuing to play the same gaming machine due to the variation in game play on the gaming machine. Furthermore, since the electronic controller controls operation of the gaming machine, the present disclosure can be readily implemented to existing gaming machines, including EGMs, electro-mechanical or purely mechanical gaming machines as well as other gaming systems. In all these respects, the present disclosure represents a practical and commercially significant improvement over the prior art.

In conclusion, although the preceding text sets forth a detailed description of different embodiments of the present disclosure, it should be understood that the legal scope of the present disclosure is defined by the words of the claims set forth at the end of this patent. The detailed description is to be construed as exemplary only and does not describe every possible embodiment of the present disclosure since describing every possible embodiment would be impractical, if not impossible. Numerous alternative embodiments could be implemented, using either current technology or technology developed after the filing date of this patent, which would still fall within the scope of the claims defining the present disclosure.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

1. A gaming machine comprising:
a display;
an electronic controller coupled to a display, the electronic controller being configured to display a game on the display including one or more configurations of game symbols displayed in symbol positions arranged in two or more predefined groups of one of more symbol positions, one or more of the configurations of game symbols being associated with a winning game outcome, the winning game outcome being associated with a value award payable to a player; and
a value transfer mechanism for receiving value from the player, wherein the electronic controller communicates with the value transfer mechanism such that when a threshold amount of value has been received from the value transfer mechanism, the electronic controller initiates a play of the game;
the electronic controller being configured to:
randomly designate one or more symbol positions as a bonus symbol position;
randomly determine, for each predefined group, whether to display a bonus symbol in one or more of the symbol positions of the predefined group, each predefined group having a probability of displaying the bonus symbol in the predefined group; and
award a bonus value award in response to one or more bonus symbols appearing in the bonus symbol positions, the bonus value award being associated with the bonus symbol;
wherein the probability of a symbol position being designated as a bonus symbol position depends on the probability of displaying the bonus symbol in the predefined group.

2. The gaming machine of claim 1, wherein the probability of a symbol position being designated as a bonus symbol position is less than the probability of displaying the bonus symbol in the predefined group.

3. The gaming machine of claim 1, wherein the probability of a symbol position being designated as a bonus symbol position is higher than the probability of displaying the bonus symbol in the predefined group.

4. The gaming machine of claim 1, wherein the predefined groups are associated with one or more different sets of the game symbols and bonus symbols and a set is selected for at least one predefined group based on the bet made by the player to play the game.

5. The gaming machine of claim 4, wherein an increase in the amount of the bet made by the player results in selection of a set having a greater number of bonus symbols for the at least one predefined group.

6. The gaming machine of claim 4, wherein there are different types of bonus symbols, each type of bonus symbol being associated with a different bonus value award and wherein an increase in the amount of the bet made by the player results in selection of a set having a greater number of bonus symbols of one or more types of bonus symbol that are associated with higher bonus value awards.

7. The gaming machine of claim 1, wherein there are different types of bonus symbols, each type of bonus symbol being associated with a different bonus value award.

8. The gaming machine of claim 1, wherein there is a constant number of bonus symbol positions designated in each play of the game.

9. A gaming machine comprising:
a display;
an electronic controller coupled to a display, the electronic controller being configured to display a game on the display including a plurality of randomly selected game symbols arranged in a plurality of reels, one or more of the configurations of the randomly selected game symbols arranged along a pay line being associated with a winning game outcome, the winning game outcome being associated with a value award payable to a player; and
a value transfer mechanism for receiving value from the player, wherein the electronic controller communicates with the value transfer mechanism such that when a threshold amount of value has been received from the value transfer mechanism, the electronic controller initiates a play of the game;
the electronic controller being configured to:
randomly designate one or more symbol positions on the reels as a bonus symbol position;
randomly determine, for each reel, whether to display a bonus symbol in one or more bonus symbol positions of the reel based on a probability of displaying the bonus symbol on the reel; and
award a bonus value award in response to one or more bonus symbols appearing in the bonus symbol positions, the bonus value award being associated with the bonus symbol;
wherein the probability of a symbol position being designated as a bonus symbol position depends on the probability of displaying the bonus symbol on the reel.

10. The gaming machine of claim 9, wherein the probability of a symbol position being designated as a bonus symbol position is less than the probability of displaying the bonus symbol in the reel.

11. The gaming machine of claim 9, wherein the probability of a symbol position being designated as a bonus symbol position is higher than the probability of displaying the bonus symbol in the reel.

12. The gaming machine of claim 9, wherein each reel is associated with one or more reel strips having a plurality of game symbols and bonus symbols, wherein a reel strip is selected for at least one reel based on the bet made by the player to play the game.

13. The gaming machine of claim 12, wherein an increase in the amount of the bet made by the player results in selection of a reel strip having a greater number of bonus symbols.

14. The gaming machine of claim 12, wherein there are different types of bonus symbols, each type of bonus symbol being associated with a different bonus value award and wherein an increase in the amount of the bet made by the player results in selection of a reel strip having a greater number of bonus symbols of one or more types of bonus symbols that are associated with higher bonus value awards.

15. The gaming machine of claim 9, wherein there are different types of bonus symbols, each type of bonus symbol being associated with a different bonus value award.

16. The gaming machine of claim 9, wherein there is a constant number of bonus symbol positions designated in each play of the game.

17. A gaming machine comprising:
a display;
an electronic controller coupled to a display, the electronic controller being configured to display a game on the display including one or more configurations of game symbols displayed in symbol positions, one or more of the configurations of game symbols being associated with a winning game outcome, the winning game outcome being associated with a value award payable to a player; and
a value transfer mechanism for receiving value from the player, wherein the electronic controller communicates with the value transfer mechanism such that when a threshold amount of value has been received from the value transfer mechanism, the electronic controller initiates a play of the game;
the electronic controller being configured to:
designate one or more symbol positions as a bonus symbol position;
randomly determine, for each bonus symbol position, whether to display a bonus symbol in the bonus symbol position; and
award a bonus value award in response to one or more bonus symbols appearing in the bonus symbol positions, the bonus value award being associated with the bonus symbol;
wherein the number of bonus symbol positions that are designated is dependent on the bet made by the player to play the game.

18. The gaming machine of claim 17, wherein the number of bonus symbol positions that are designated increases as the amount of the bet increases.

19. The gaming machine of claim 17, wherein the number of bonus symbol positions increases for one or more successive plays of the game.

20. The gaming machine of claim 17, wherein a multiplier is associated with the bonus symbol positions and the multiplier, when activated, increases the amount of the bonus value award.

21. The gaming machine of claim 20, wherein the multiplier is activated when at least one bonus symbol appears in one of the bonus symbol positions or upon payment of an ante bet.

22. The gaming machine of claim 20, wherein the multiplier is randomly selected from a range of multipliers from a multiplier reel.
